(19) United States
(12) Patent Application Publication
(10) Pub. No.: US 2024/0315164 A1
(43) Pub. Date: Sep. 26, 2024

(54) AUTOMATED PLANT DISPENSING SYSTEMS AND METHODS

(71) Applicant: Zenon Agritech, LP, Arroyo Grande, CA (US)

(72) Inventor: Hoy Ayers Buell, Arroyo Grande, CA (US)

(21) Appl. No.: 18/612,993

(22) Filed: Mar. 21, 2024

Related U.S. Application Data
(60) Provisional application No. 63/453,831, filed on Mar. 22, 2023.

(51) Int. Cl. A01C 11/02; A01C 11/00

(52) U.S. Cl. CPC A01C 11/025; A01C 11/006

(57) ABSTRACT

A plant dispensing unit for planting plants may include a set of ejectors for engaging and retaining plant balls of a row of plant balls in a tray having a plurality of rows. Each ejector may be configured to eject the engaged plant ball with force. A plant dispensing unit may include a funnel assembly configured to receive an ejected plant ball and direct it to a shoe configured to receive the ejected plant ball from the funnel and position the plant ball for planting. A plant dispensing unit may include a control system coupled to an ejector drive system a shoe drive system, for operatively coordinating actions of the plant dispensing unit. A plant dispensing unit may include a flat feeder for operating a tray feeding system of the plant dispensing unit to index rows of the tray for engagement by the ejectors.

### CROSS-REFERENCE TO RELATED APPLICATIONS

This application claims the benefit of U.S. Provisional Application No. 63/453,831, filed Mar. 22, 2023, for MECHANICAL TRANSPLANTER, which is incorporated in its entirety herein by reference.

### BACKGROUND OF THE INVENTION

### 1. Field of the Invention

The present version of these embodiments relate generally to the field of automatic mechanical planters for plants and cuttings.

### 2. Discussion of the Related Art

These embodiments relate to mechanical planting of plants and cuttings, and more particularly to devices that can automate what has been traditionally been a manual operation in the planting of plants into the ground or soil for crop production. While this description will reference “plants” it should be understood to incorporate all things that are planted into the ground to include cuttings, flowers and others.

Farming is very important for all nations and economies. Farming consumes water resources and generally requires much unskilled hand labor. Hand labor is getting more and more difficult to find and that which is found, is becoming expensive. It would be useful if some of this hand labor could be eliminated for repetitive operations in the farming industry. This would result in less over head for the farmers and growers and quite possibly a better quality product.

Generally crops are started in greenhouse operations in cell feed trays. This allows the growing season to be extended and gets the plants to a size where they can more easily be replanted in the soil. The seeds or cuttings are planted indoors and are cared for until they reach a pre-determined size. For the farms that do commercial plantings, the numbers of plants that require replanting can be extremely numerous. The quicker they can get the plants in the ground the quicker the plants will mature and produce product. Hand labor can be unreliable and inconsistent where mechanical devices, once dialed in, are more reliable and efficient.

Plants or cuttings can also grow too much indoors. This results in complex rooting which can make the removal of plants from the tray cells difficult and result in plant losses.

There are also visual cues that can indicate if a plant has a good chance of becoming productive. This visual inspection can be learned but requires concentration and experience. It can be difficult to find labor that can do this inspection in a consistent speedy manner. It would be helpful if there was some type of vision or inspection or sensor system available that would screen those plants that did not have a good chance of becoming productive. It is not efficient to put resources into a plant that does not have a good chance of producing saleable product.

An inspection system can also be used to determine if there is or is not a plant growing in a feeder tray cell before an attempt is made to pull the plant or plant ball from the cell. The inspection system can be used to tell the system to “skip” a cell that does not have growth for transplanting.

So there is pressure to get the plants grown, pressure to get them to a certain size by a certain planting date, then pressure to get them removed from the tray cells and into the ground or planted. Any time saved in any of these operations contributes to the overall efficiency and profitability of the farm or any entity involved in the growing process. Mechanical efficiency, once dialed in, can be much more efficient and less expensive than manual labor.

For the foregoing reasons, there is a need for a mechanical transplanter for plants.

### SUMMARY OF THE INVENTION

In some aspects, the techniques described herein relate to a plant dispensing unit for planting plants, including: a frame including a release bar; an ejector assembly coupled to the frame, the ejector assembly including: an ejector assembly housing; a set of ejectors mounted to the ejector assembly housing in a row, wherein each ejector has a fork configured to engage a plant ball of a row of plant balls in a tray having a plurality of rows, and retain the engaged plant ball on the fork, wherein each ejector has an ejector release mechanism with biasing means configured to eject the engaged plant ball with force, and a release assembly configured to load, lock and release the ejector release mechanism; and an ejector drive system configured to translate the set of ejectors horizontally and vertically between a plant ball-engaging position and a plant ball-ejecting position and to index the set of ejectors for ejecting each engaged plant ball into a funnel; a funnel assembly in spaced relation to the frame and including a funnel configured to receive an ejected plant ball and direct it to a shoe; a shoe assembly in spaced relation to the frame, the shoe assembly including: the shoe configured to receive the ejected plant ball from the funnel and position the plant ball for planting; a shoe mechanism configured to plant the positioned plant ball into soil; and a shoe drive system configured to operatively control the shoe mechanism to plant the plant ball into the soil; and a control system coupled to the ejector drive system and the shoe drive system, for operatively coordinating actions of the plant dispensing unit, wherein the plant dispensing unit is configured to perform the following actions: a) move the set of ejectors to the plant ball-engaging position, b) move the set of ejectors to engage each plant ball of the row of plant balls on the fork of the corresponding ejector, whereby the engaging of each plant ball on the corresponding ejector loads and locks the ejector release mechanism, c) move the set of ejectors to the plant ball-ejecting position, whereby a first ejector is positioned proximate to the funnel, d) in response to moving the set of ejectors, causing the release assembly to release the ejector release mechanism, whereby the biasing of the ejector release mechanism causes the plant ball to be ejected into the funnel with force, thereby sending the ejected plant ball through the funnel to the planting position of the shoe and ultimately into the soil, e) for an unpositioned second ejector, index the set of ejectors to position the unpositioned second ejector proximate to the funnel, causing the release assembly to release the ejector release mechanism of the second ejector, whereby the biasing of the ejector release mechanism of the second ejector causes the plant ball to be ejected into the funnel with force, thereby sending the ejected plant ball through the funnel to the planting position of the shoe and ultimately into the soil, and f) repeat step e) until all plant balls have been ejected.

In some aspects, the techniques described herein relate to a plant dispensing unit, the shoe mechanism further including: a kicker arm having one end movably coupled to the frame and a free end having a hammer, wherein the hammer is configured to move between forwards and rearwards positions, wherein when the plant ball is positioned in the shoe for planting, the hammer is moved rearwards to contact the plant ball with the hammer, thereby planting the plant ball into the soil.

In some aspects, the techniques described herein relate to a plant dispensing unit, wherein the shoe drive system is configured to operate the kicker arm so that the hammer moves forwards at a faster rate than the hammer moves rearwards.

In some aspects, the techniques described herein relate to a plant dispensing unit, further including a sensor coupled to the frame and configured to check that the ejector has engaged the plant ball, and wherein the plant dispensing unit is further configured to: for each ejector positioned proximate to the funnel but prior to ejecting, determine using the sensor whether the positioned ejector has engaged the plant ball; and during steps d) and e), releasing the ejector mechanism only upon determining that the positioned ejector has engaged the plant ball.

In some aspects, the techniques described herein relate to a plant dispensing unit, wherein the sensor is an infrared sensor and the plant dispensing unit further includes an infrared laser.

In some aspects, the techniques described herein relate to a plant dispensing unit, the funnel further including an upper perimeter having an oval shape and a lower perimeter having a circular shape, and the funnel further including a tube coupled to the lower perimeter.

In some aspects, the techniques described herein relate to a plant dispensing unit, the funnel further including a guiding tab extending downwards from a front side of a lower end of the tube.

In some aspects, the techniques described herein relate to a plant dispensing unit, further including a flat feeder coupled to the frame and configured to index the tray of plant balls for engagement of each row of plant balls in the tray.

In some aspects, the techniques described herein relate to a plant dispensing unit, the flat feeder including a tray feeding system including: drive components configured to index the tray of plant balls; and a tray feed drive system configured to operate the drive components, wherein the tray feed drive system is coupled to the control system.

In some aspects, the techniques described herein relate to a plant dispensing unit, the flat feeder further including a brake system configured to slow a rate of downward travel of a tray loaded into the flat feeder

In some aspects, the techniques described herein relate to a plant dispensing unit, wherein the ejector drive system and the shoe drive system each include an electric motor and a drive.

In some aspects, the techniques described herein relate to a plant dispensing unit, wherein the locked release assembly is released by the release bar engaging the release assembly when the ejector is positioned proximate to the funnel, whereby the biasing means of the ejector mechanism is released.

In some aspects, the techniques described herein relate to a method for dispensing plants, including the steps of: a) moving a set of ejectors of a plant dispensing unit to a plant ball-engaging position, wherein each ejector has a fork configured to engage a plant ball of a row of plant balls in a tray having a plurality of rows, and further configured to retain the engaged plant ball on the fork, wherein each ejector has an ejector release mechanism with biasing means configured to eject the engaged plant ball with force, each ejector further including a release assembly configured to lock, load, and release the ejector release mechanism; b) moving the set of ejectors to engage each plant ball of the row of plant balls on the fork of the corresponding ejector, whereby the engaging of each plant ball on the ejector loads and locks the ejector release mechanism, c) moving the set of ejectors to a plant ball-ejecting position, whereby a first ejector is positioned proximate to a funnel of the plant dispensing unit, d) in response to moving the set of ejectors, causing the release assembly to release the ejector release mechanism, whereby the biasing of the ejector release mechanism causes the plant ball to be ejected into the funnel with force, thereby sending the ejected plant ball through the funnel to a shoe of the plant dispensing unit, whereby the plant ball is positioned in the shoe for planting into soil, e) for an unpositioned second ejector, indexing the set of ejectors to position the unpositioned second ejector proximate to the funnel, causing the release assembly to release the ejector release mechanism of the second ejector, whereby the biasing of the ejector release mechanism of the second ejector causes the plant ball to be ejected into the funnel with force, thereby sending the ejected plant ball through the funnel to the planting position of the shoe and ultimately into the soil f) repeating step e) until all plant balls have been ejected.

In some aspects, the techniques described herein relate to a method for dispensing plants, further including the step of: for each plant ball positioned in the shoe, operating a kicker arm of the plant dispensing unit to push the plant ball rearwards, whereby the plant ball is planted into the soil.

In some aspects, the techniques described herein relate to a method for dispensing plants, further including the step of: after operating the kicker arm to push the plant ball rearwards, moving the kicker arm forwards to reset the kicker arm position.

In some aspects, the techniques described herein relate to a method for dispensing plants, further including the steps of: for each ejector positioned proximate to the funnel prior to ejecting, determine using a sensor of the plant dispensing unit whether the positioned ejector has engaged the plant ball; and during steps d) and e), releasing the ejector mechanism only upon determining that the positioned ejector has engaged the plant ball.

In some aspects, the techniques described herein relate to a method for dispensing plants, wherein the sensor is an infrared sensor and the plant dispensing unit further includes an infrared laser.

In some aspects, the techniques described herein relate to a method for dispensing plants, further including the step of: when all plant balls in a row have been engaged by ejectors, operating a tray feeding system of the plant dispensing unit to index the next row for engagement.

In some aspects, the techniques described herein relate to a plant dispensing unit, wherein the causing the release assembly to release the ejector release mechanism further includes wherein the locked release assembly is released by a release bar engaging the release assembly when the ejector is positioned proximate to the funnel, whereby the biasing means of the ejector mechanism is released.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 shows a front perspective view of one embodiment of a mechanical transplanter.

FIG. 2 shows a front view of one embodiment of a mechanical transplanter.

FIG. 3 shows a front perspective view of one embodiment of several important elements with elements missing showing a grabber in a first position.

FIG. 4 shows a front perspective view of one embodiment of several important elements with elements missing showing a grabber in a second position

FIG. 5 a front perspective view of one embodiment of several important elements with elements missing showing an overall view of how the device interacts with existing structure.

FIG. 6 shows a front left side perspective view of one embodiment of the device with cover pieces removed to see the internal elements.

FIG. 7 shows a front perspective view of one embodiment of the device with cover pieces removed to see the internal elements.

FIG. 8 shows a rear bottom perspective view of one embodiment of the device showing one embodiment of the inspection, vision or sensor system.

FIG. 9 shows a front bottom perspective view of one embodiment of the device showing the arrangement of elements with grabbers in the first position.

FIG. 10 shows a front side view of one embodiment of a grabber.

FIG. 11 shows a back side view of one embodiment of the grabber of FIG. 10.

FIG. 12 shows a fork with tines which are used to grasp a plant or plant ball.

FIG. 13 shows a back side drawing of one embodiment of a grabber.

FIG. 14 shows a right side view of another embodiment of a mechanical transplanter.

FIG. 15 shows a left side view of the embodiment of FIG. 14.

FIG. 16 shows a rear side view of the embodiment of FIG. 14.

FIG. 17 shows a front side view of the embodiment of FIG. 14

FIG. 18 shows a bottom view of the embodiment of FIG. 14.

FIG. 19 shows a top view of the embodiment of FIG. 14.

FIG. 20 shows a top front right side perspective view of the embodiment of FIG. 14.

FIG. 21 shows a bottom right side perspective view of the embodiment of FIG. 14.

FIG. 22 shows a front left side perspective view of the embodiment of FIG. 14.

FIG. 23 shows a right side view of the embodiment of FIG. 14 with some elements in a different position.

FIG. 24 shows a left side view of the embodiment of FIG. 14 with some elements in a different position.

FIG. 25 shows a bottom right side perspective view of the embodiment of FIG. 14 with some elements in a different position.

FIG. 26 shows a top left side perspective view of the embodiment of FIG. 14 with some elements in a different position.

FIG. 27 shows a right side view of the embodiment of FIG. 14 with some elements in another position.

FIG. 28 shows a left side view of the embodiment of FIG. 14 with the some elements in another position.

FIG. 29 shows a rear view of the embodiment of FIG. 14 with some elements in another position.

FIG. 30 shows a front view of the embodiment of FIG. 14 with some elements in another position.

FIG. 31 shows a top right perspective view of the embodiment of FIG. 14 with some elements in another position.

FIG. 32 shows a right bottom perspective view of the embodiment of FIG. 14 with some elements in another position.

FIG. 33 shows a left top perspective view of the embodiments of FIG. 14 with some elements in another position.

FIG. 34 shows one side of one embodiment of a grabber showing how the plant balls are retained and released.

FIG. 35 shows a second side of one embodiment of a grabber to help explain how the spring driving system works.

FIG. 36 shows a perspective view of the second side of the embodiment of FIG. 35.

FIG. 37 shows one embodiment of a partial second side perspective view of the grabber and interaction with a partial view of the trigger mechanism and partial view of the translation mechanism.

FIG. 38 shows one embodiment of a partial second side perspective view of the grabber and interaction with a partial view of the trigger mechanism in a different position and partial view of the translation mechanism.

FIG. 39 shows one side of one embodiment of the trigger mechanism with trigger in the non-active position.

FIG. 40 shows one side of one embodiment of the trigger mechanism with the trigger in the active position.

FIG. 41 shows one side of one embodiment of a grabber in one position and interaction with partial views of the funnel, sensor, trigger, trigger mechanism and translation mechanism.

FIG. 42A shows one side of one embodiment of a grabber in another position and interaction with partial views of the funnel, sensor, trigger mechanism and translation mechanism

FIG. 42B shows one side of one embodiment of a grabber in another position and interaction with partial views of the trigger mechanism, translation mechanism and feeder.

FIG. 43 shows one side of one embodiment of a grabber in a pre-loading position and interaction with partial views of the trigger, trigger mechanism, translation mechanism and feeder.

FIG. 44 shows one side of one embodiment of a grabber in a beginning loading position and interaction with partial views of the translation mechanism and feeder.

FIG. 45 shows one side of one embodiment of a grabber in a loaded position and interaction with partial views of the translation mechanism and feeder.

FIG. 46 shows one side of one embodiment of a grabber in a beginning return position and interaction with partial views of the translation mechanism and feeder.

FIG. 47A shows one side of one embodiment of a grabber in a returning position and interaction with partial views of the trigger, trigger mechanism and translation mechanism.

FIG. 47B shows one side of one embodiment of a grabber in a returning position and interaction with partial views of the sensor, trigger, trigger mechanism and translation mechanism.

FIG. 48 shows one side of one embodiment of a grabber nearing the sensor position and interaction with partial views of the sensor, trigger, trigger mechanism and translation mechanism.

FIG. 49 shows one side of one embodiment of a grabber in a sensing position and interaction with partial views of the funnel, sensor, trigger, trigger mechanism and translation mechanism.

FIG. 50 shows one side of one embodiment of a grabber in a post sensing position and interaction with partial views of the funnel, sensor, trigger, trigger mechanism and translation mechanism.

FIG. 51 shows one side of one embodiment of a grabber in a pre-dispensing position and interaction with partial views of the funnel, sensor, trigger, trigger mechanism and translation mechanism.

FIG. 52 shows one side of one embodiment of a grabber in a partial un-loaded position and interaction with partial views of the funnel, sensor, trigger, trigger mechanism and translation mechanism.

FIG. 53 shows one side of one embodiment of a grabber in a post dispensing position and interaction with partial views of the funnel, sensor, trigger, trigger mechanism and translation mechanism.

FIG. 54A shows a right side perspective view of another embodiment of a dispensing unit 237.

FIG. 54B shows a right side elevation view of the dispensing unit of FIG. 54A with camera 277 and sensor 278.

FIG. 54C shows a front view of the dispensing unit of FIG. 54A.

FIG. 55A shows another right side perspective view of the a dispensing unit 237.

FIG. 55B shows a plan view of the dispensing 237 of FIG. 55A.

FIG. 55C shows a right side elevation view of the dispensing unit 237 of FIG. 55A.

FIG. 55D shows a bottom view of the dispensing unit 237 of FIG. 55A.

FIG. 55E shows an end view of the dispensing unit 237 of FIG. 55A from the dispenser side.

FIG. 56A shows a top perspective view of another embodiment of an ejector drive system.

FIG. 56B shows a side view of the ejector drive system of FIG. 56A.

FIG. 56C shows a front dispenser side end view of the ejector drive system of FIG. 56A.

FIG. 56D shows an exploded view of the elements of the ejector drive system of FIG. 56A.

FIG. 57A shows a perspective view of a drive rail 241 with a dispensing unit or ejector assembly 243.

FIG. 57B shows a second perspective view of the drive rail 241 and ejector or dispensing unit assembly 243 of FIG. 57A.

FIG. 57C shows a side view of the drive rail 241.

FIG. 57D shows a side view of the drive rail 241 and ejector assembly 243.

FIG. 57E shows a front end view of the drive rail 241 and ejector assembly 243 in the horizontal or grabbing position.

FIG. 57F shows a front end view of the dispensing unit assembly in the vertical position.

FIG. 58A shows a front perspective view of another embodiment of an ejector housing assemblage 244.

FIG. 58B shows a front view of the ejector housing assemblage 244 of FIG. 58A.

FIG. 59A shows an exploded view of the ejector housing assemblage 244 and affixed to an arm 248 showing various elements thereof.

FIG. 59B shows another exploded view of the ejector housing assemblage 244 showing various element thereof.

FIG. 60A shows an exploded view of the ejector housing assemblage 244 with various elements removed to better understand their interaction.

FIG. 60B shows another exploded view of the ejector housing assemblage 244 with various elements removed to better understand their interaction.

FIG. 61A shows a perspective view of one embodiment of the flat feeder 251 affixed to a dispensing unit 237.

FIG. 61B shows a back end view of the dispensing unit 237 affixed to an embodiment of the flat feeder 251.

FIG. 61C shows an elevation side view of the dispensing unit 237 affixed to an embodiment of the flat feeder 251.

FIG. 61D shows a bottom view of the dispensing unit 237 with the flat feeder 251 affixed.

FIG. 61E shows a front view of the dispensing assemblage.

FIG. 61F shows a detail of the perspective view of FIG. 61A.

FIG. 62A shows a rear view of the flat feeder 251 with components removed.

FIG. 62B shows a side view of the flat feeder 251 and cover 255.

FIG. 62C shows a front perspective view of the flat feeder cover 255 with elements removed.

FIG. 62D shows a rear perspective view of the flat feeder cover 255 with elements removed.

FIG. 62E shows a top plan view of the flat feeder.

FIG. 63A shows rear view of one embodiment of the motor 258, drive shaft 259, and flat index gear or wheel 260 of the tray feeding system 257.

FIG. 63B shows a side view of the tray feeding system 257 shown in FIG. 63A.

FIG. 63C shows a perspective view of the tray feeding system 257 and cover.

FIG. 63D shows the other side of the tray feeding system 257 shown in FIG. 63A.

FIG. 63E shows a rear view of the feeding system cover.

FIG. 63F shows a side view of the feeding system cover.

FIG. 64A shows a perspective view of the tray feeding system 257 and its other components. FIG. 64B shows a side end view of the tray feeding system 257 from FIG. 64A.

FIG. 64C shows a front view of the tray feeding system 257 and other components. FIG. 64D shows a top view of the tray feeding system 257 and attached components.

FIG. 64E shows a sectional view of the index gear of the tray feeding system 257.

FIG. 65A shows a perspective view of another embodiment of the planting shoe mechanism 263 with components removed to view the interior.

FIG. 65B shows a perspective view of the planting shoe mechanism 263 of FIG. 65A with components added.

FIG. 65C shows a side view of the planting shoe mechanism 263.

FIG. 65D shows a top view of the planting shoe mechanism 263 showing another embodiment of the funnel 264.

FIG. 66A shows a top perspective view of another embodiment of the funnel 264 and funnel assembly 268.

FIG. 66B shows a side view of one embodiment of the funnel assembly 268.

FIG. 66C is a front view of one embodiment of the funnel assembly 268.

FIG. 67 is a flowchart of an example method for dispensing plants.

FIG. 68 is a schematic diagram of control systems for the plant dispensing unit.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

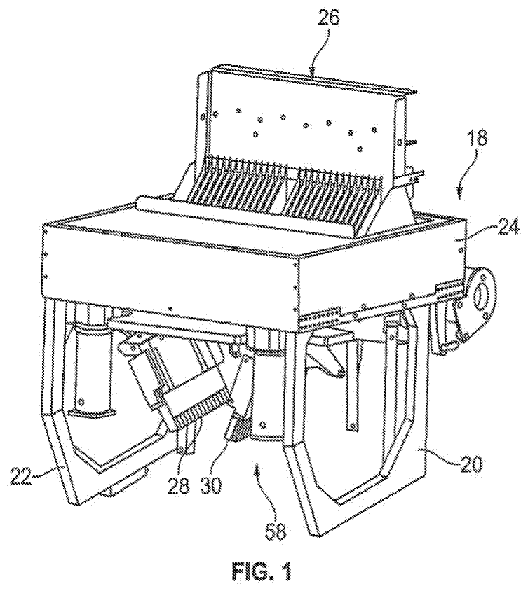

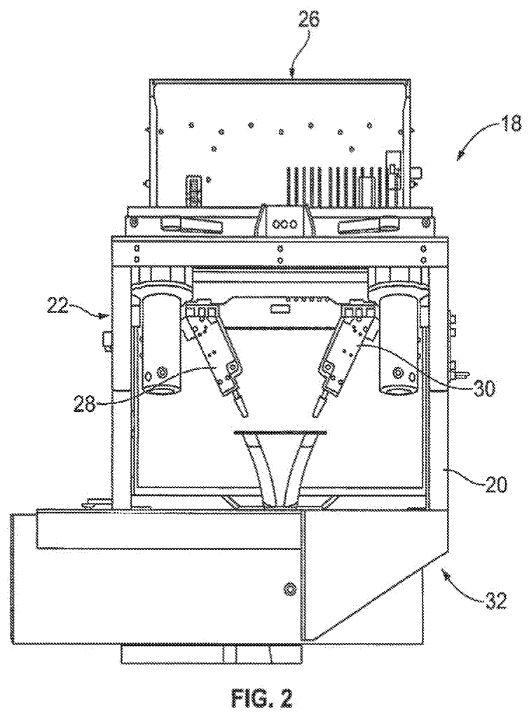

Referring to the drawings in detail wherein like elements are indicated by like numerals, there is shown in FIG. 1 one embodiment of a mechanical transplanter 18. The transplanter 18 has a left frame 22 and a right frame 20. A cover 24 covers elements below, the cover 24 is needed to keep sunlight off of the roots of plants (not shown) as sunlight can adversely affect the plant roots and growth. Also shown in FIG. 1 is a feeder 26. Feeder 26 receives trays full of plants having stems and leaves and organizes the plants 38 such that they can be plucked by the right and left grabbers 30, 28. FIG. 1 shows the grabbers 28, 30 in the first position 58 FIG. 2 shows a front view of the mechanical transplanter 18. FIG. 2 shows how the transplanter 18 interacts with existing technology.

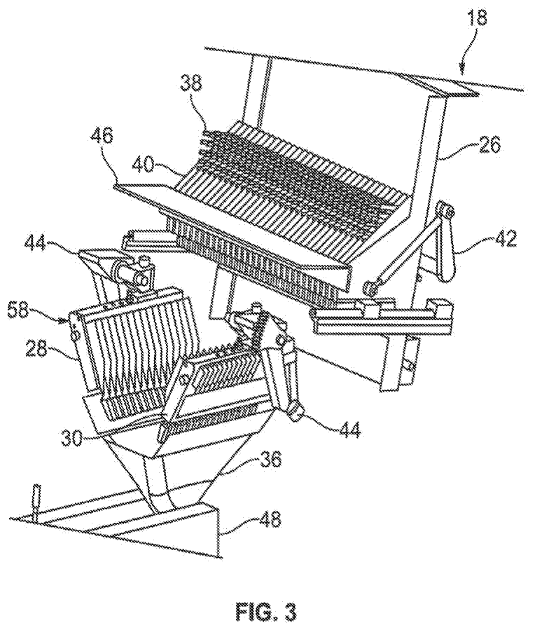

FIG. 3 shows a front perspective view of some elements with others removed to better view and explain how they function together. The feeder 26 is seen to have a feeder drive 42 which translates the feeder 26 horizontally towards and away from the grabbers 28, 30. The grabbers 28, 30 are shown in the first position 58 from which the plants 38 are dispensed into the funnel 36.

The plants 38 get loaded into the feeder 26 such that the stems and leaves are in an approximately horizontal position away from the feeder 26. The feeder 26 has partitions 40 into which the stems and leaves are located. As can be seen, the partitions 40 angle to allow the stems and leaves to be configured in an untangled position relative to one another. This aids in the removal of the plants 38 from the tray 43 cells 41.

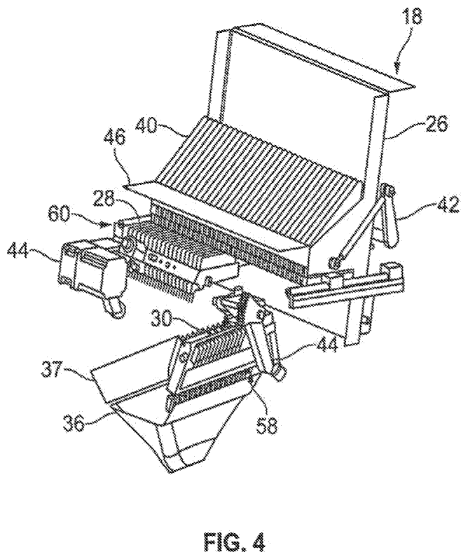

FIG. 4 shows a front perspective view similar to that of FIG. 3. For explanation purposes, left grabber 28 will be used to explain how the device functions. It should be understood that right grabber 30 would function in nearly the same manner. In FIG. 4, the left grabber 28 is shown in the second position 60. The left grabber 28 is rotated from an angled vertical position to that of approximately horizontal and from this position is translated such that the fork 92 bottom 112 can engage the plants 38 to pluck them from the tray 43 cells 41. It is here that the vision system 70 is utilized to indicate to the left grabber 28 if there are any plants 38 that may not meet the standards. The vision system can aid in grasping and can indicate even if there is or is not a plant 38 present in the cell 41. Once the plants 38 are grasped by the left grabber 28, the grabber translates horizontally and vertically to return to the first position 58 as exemplified in FIG. 4 by right grabber 30.

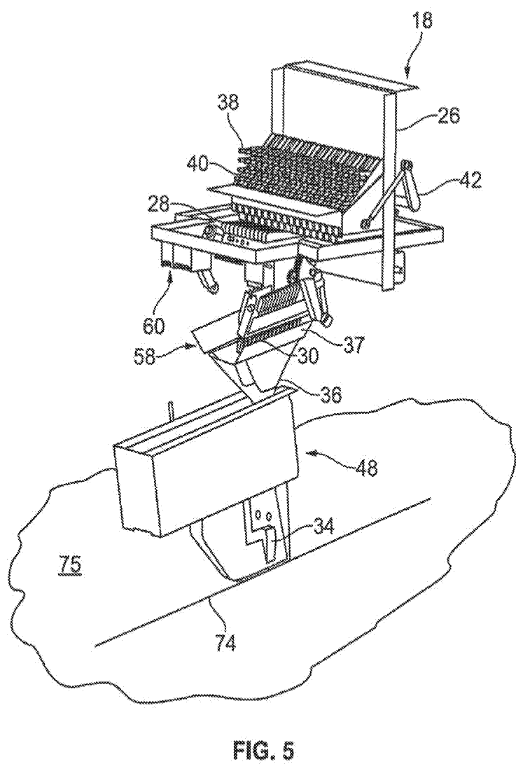

FIG. 5 shows another front perspective view of the device with several components missing to further the discussion of how the elements function and are arranged. This FIG. 5 shows the left grabber 28 in the second position 60 and the right grabber 30 in the first position 58. Also more visible in this figure are the funnel 36 and funnel plate 37 which feed into the shoe assembly 48 and eventually in to the row 74 in the soil 75.

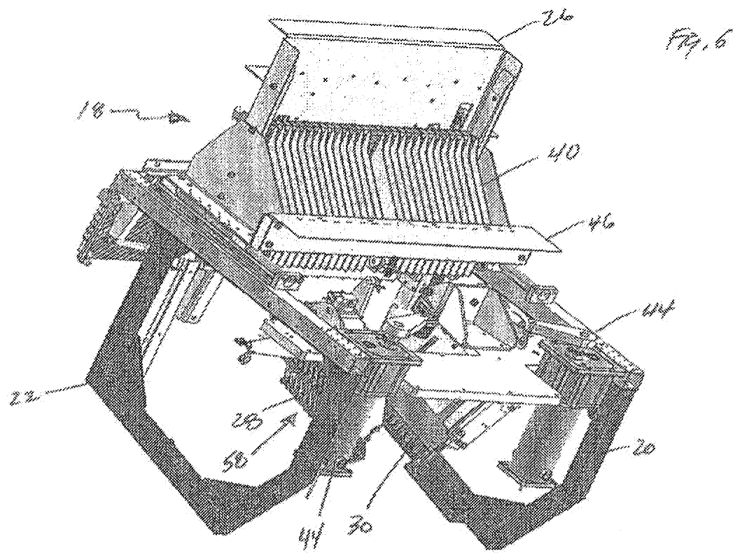

FIG. 6 shows another front perspective view of the mechanical transplanter 18 from the opposite side as that shown in FIGS. 3 and 4 and with various additional elements shown. This shows the grabber drive 44 on the right grabber 30, also can be seen the grabber drive 44 on the left grabber 28.

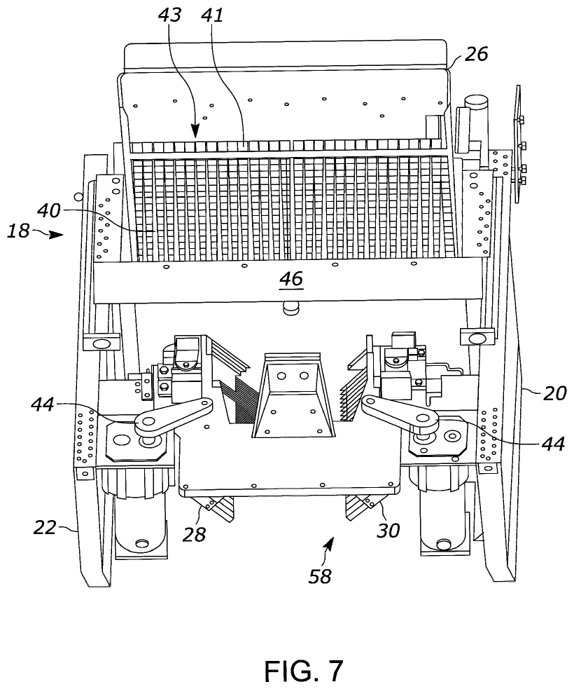

FIG. 7 shows a front perspective view of the mechanical transplanter 18. This view shows the cells 41 in the tray 43 more clearly. Also shown is plate 46 which helps retain the partitions 40 in a parallel configuration to one another.

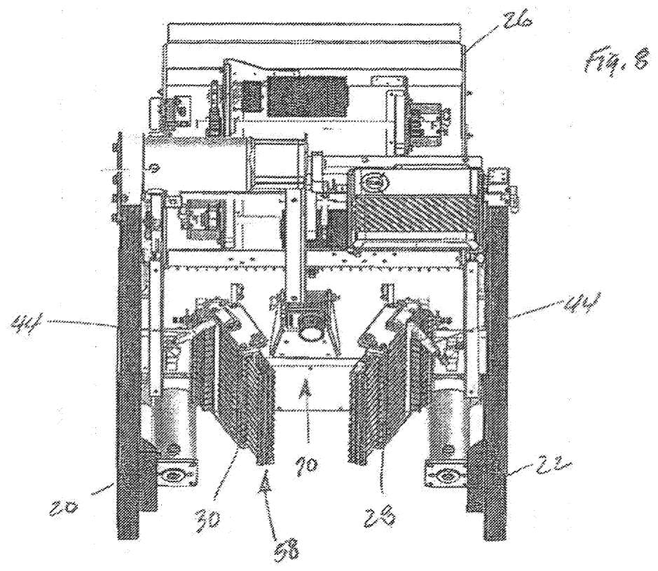

FIG. 8 shows a bottom rear perspective view of the mechanical transplanter 18. In this view is shown the vision system 70. As noted, the vision system 70 can be used to determine if there is a plant in an individual cell 41 before the grabbers 28, 30 remove the plants 38 from the cells 41. The vision system 70 can also be used to do a quality check on the plants 38 once removed from the cells 41. This check would help determine if the plant 38 had a good chance of flourishing or if another plant from another cell 41 should be pulled. It makes little sense to place a plant 38 that is not healthy or mis-formed.

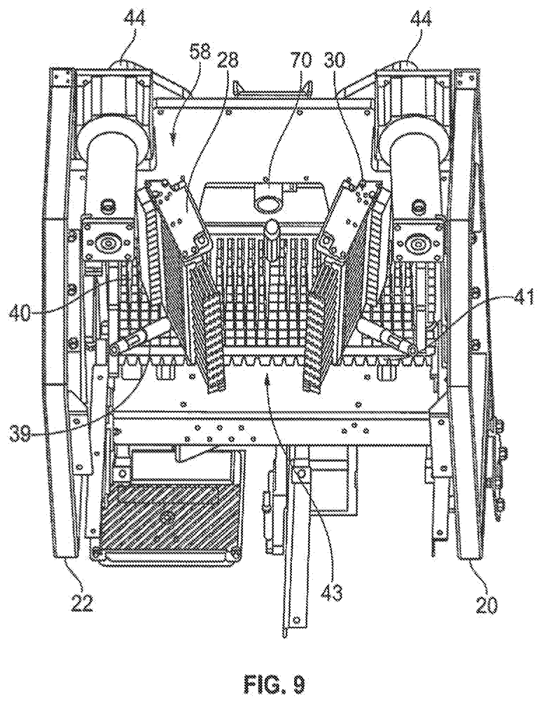

FIG. 9 is a bottom front perspective view of a mechanical transplanter 18. In this view, the cells 41 in the tray 43 can more clearly be seen in a position extending below the bottom edge 39 of the partitions 40. When the cells 41 of the tray 43 are located below the bottom edge 39 of the partitions 40, the left and right grabbers 28, 30 can pluck the plants 38 from the cells 41. As a row of plants 38 are plucked from the cells 41, the tray 43 indexes in a vertical direction towards the soil 75 (not shown this Fig.). Once all the plants 38 are removed from the cells 41 in the tray 43, the tray 43 drops onto a storage area (not shown) from where it is later collected for replanting.

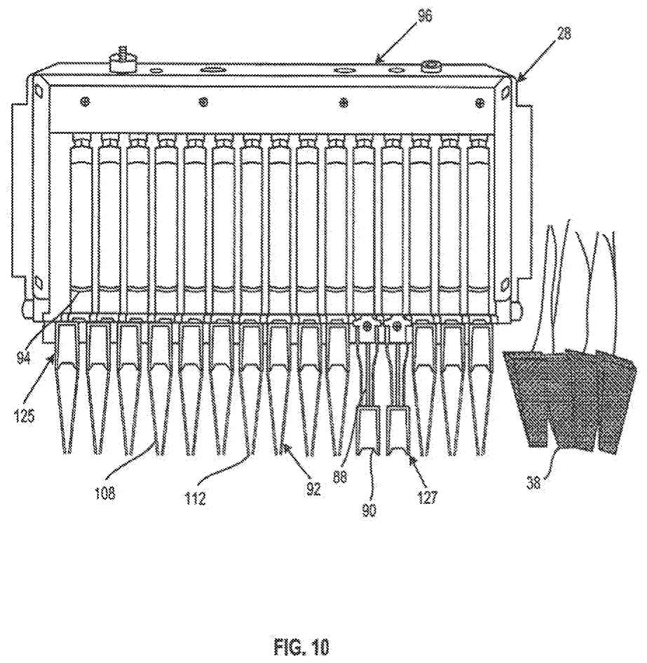

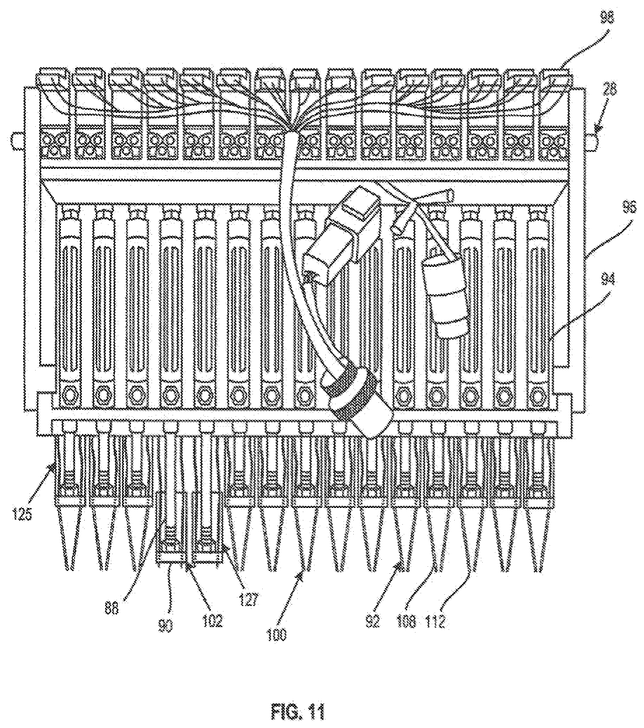

FIG. 10 shows a first side view of, as an example, the left grabber 28. FIG. 11 shows a second side view of left grabber 28.

In FIG. 11 can be seen the frame 96 that houses the elements that make up the device that both grasps the plants 38 from the individual cells 41 and also ejects with force, the plants 38 into the funnel 36 and ultimately into the soil 75. This embodiment utilizes an air cylinder 94 with controls 98. The air cylinder 94 is affixed to a pair of forks 92. The forks 92 have tines 108, generally two on each fork 92. This embodiment shows two forks 92 affixed to the each cylinder 94. Each cylinder 94 also has a rod 88 which translates into and out of the cylinder 94. A plunger block 90 is affixed to one end of the rod 88. It should be understood that other methods of ejecting the plants 38 into the funnel 38 and soil 75 could be used such as a solenoid & other mechanical, electrical or non-mechanical methods or means. This ejection of the plants 38 can be timed with other elements to optimize planting time and spacing and other parameters.

FIGS. 10 and 11 also show the translation of the plunger block 19 from a position close to the bottom of the air cylinder 94 to one away from the air cylinder 94. Both views show the tines 108 of the forks 92 engaging the plants 38. This is approximately the position that the plants 38 are in when plucked from the cells 41 of the tray 43. When the left grabber 28 would translate and rotate from the second position 60 to the first position 58, the air cylinder 94 rod 88 would be engaged and translated from within the air cylinder 94 to that position where it is at a maximum position away from the air cylinder 94. This would translate the plunger block 90 from the first position 125 to the second position 127. As can be seen, the translation of the plunger block 90 into the second position 127 would forcibly eject the plant 38 from the tines 108 of the fork 92 and into the funnel 36 and ultimately into the soil 75 thereby planting the plant 38. Other methods of ejecting the plants 38 could also be utilized as noted.

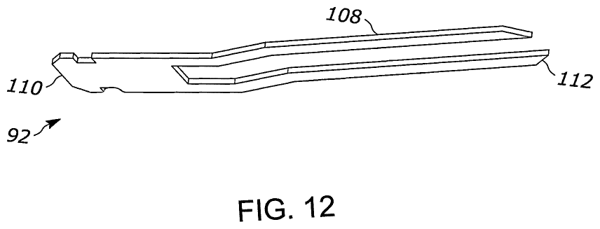

FIG. 12 shows a perspective view of one embodiment of a fork 92 having tines 108.

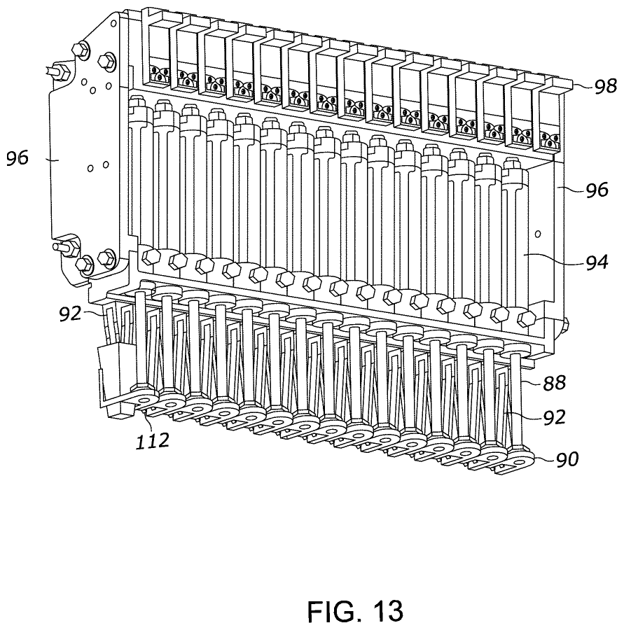

FIG. 13 shows one side of one embodiment of a grabber 30 showing the air cylinders 94 affixed to the frame 96. The air cylinders 94 have a rod 88 extending from the lower section. The rod 88 is affixed to a plunger block 90. Also affixed near the bottom of the air cylinder 94 is a fork 92.

As can be appreciated, the logic and programming of the operation of these elements can be optimized based on soil conditions, the size, shape and weight of the plants 38 that are being planted. This mechanical transplanter 18 can pluck and plant many plants 38 more consistently and with less variability than human labor.

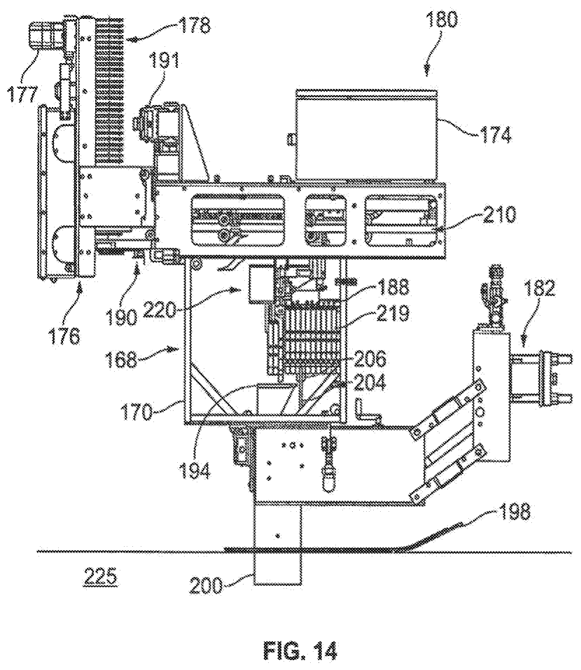

FIG. 14 shows a second embodiment of the mechanical transplanter device 180. The transplanter 180 has several components, such as a feeder 176 which houses the loaded trays 178 containing plant balls 185. This is connected to the translation mechanism 210 which has a housing and grab control 191 and grab motors 192. The translation mechanism 210 is used to translate and rotate the right grabber 190 and left grabber 188. A housing 168 is located below the translation mechanism 210. The right and left grabbers 190, 188 move from inside the housing 168 to outside the housing 168 to grasp plant balls 185 from the feeder 176 tray 178.

FIG. 14 shows right grabber 190 engaging with the feeder 176 to obtain plant balls 185. Left grabber 188 has already engaged the plant balls 185 and is ejecting them into the funnel 194. From the funnel 194 the plant balls 185 are forced through the shoe 200 and into the planting ground 225. As one plant ball 185 is ejected, the grabber 188 indexes on the translation mechanism 210 and the trigger mechanism 220 trigger 218 trips another ejector 219 to eject another plant ball 185 into the ground 225.

The mechanical transplanter 180 also has a control box 174 to control and coordinate the various elements that make up the transplanter 180. There is an electrical/mechanical connector 182 for affixing the mechanical transplanter 180 to a tractor or other device. The connector 182 can provide electrical power and mechanical power to the transplanter 180. Near the bottom of the transplanter 180 is located a ski 198. The ski 198 rides along the ground 225 to make a flat path in the ground 225 to allow the shoe 200 to direct the plant balls 185 from the ejecting grabber 188, 190.

The figures are arranged to allow better explanation of the functioning of the device as it is working planting plant balls 185 into the ground 225.

As noted FIG. 14 shows right grabber 190 engaging the feeder 176 tray 178 to engage plant balls 185. Left grabber 188 is ejecting plant balls 185 into the funnel 194, to the shoe 200 and into the ground 225. In this figure the left grabber 188 is indexing towards the left.

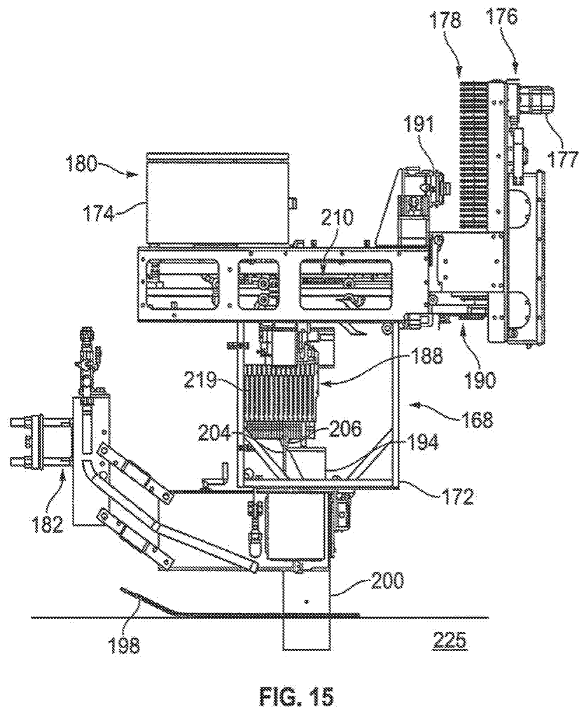

FIG. 15 shows a left side view of the mechanical transplanter 180 with the left and right grabbers 188, 190 indexed to the same position as that in FIG. 14. FIG. 15 shows the sensor plate 204 located in the housing 168 and near funnel 194. The sensor plate 204 is shaped like the capital letter E and affixed to the bottom of the housing 168 on it's long side so that the prongs of the E are upwards vertical. There are two sensor transmitters 205 located on the center post of the E and they point in opposite directions. Each exterior post of the E has a sensor receiver 206 corresponding to one sensor transmitter 205. The transmitters 205 and receivers 206 are for checking that the plant balls 185 when engaged by the grabbers 188, 190 during the cycle are present and have enough root growth to plant. This operation will be explained more fully infra.

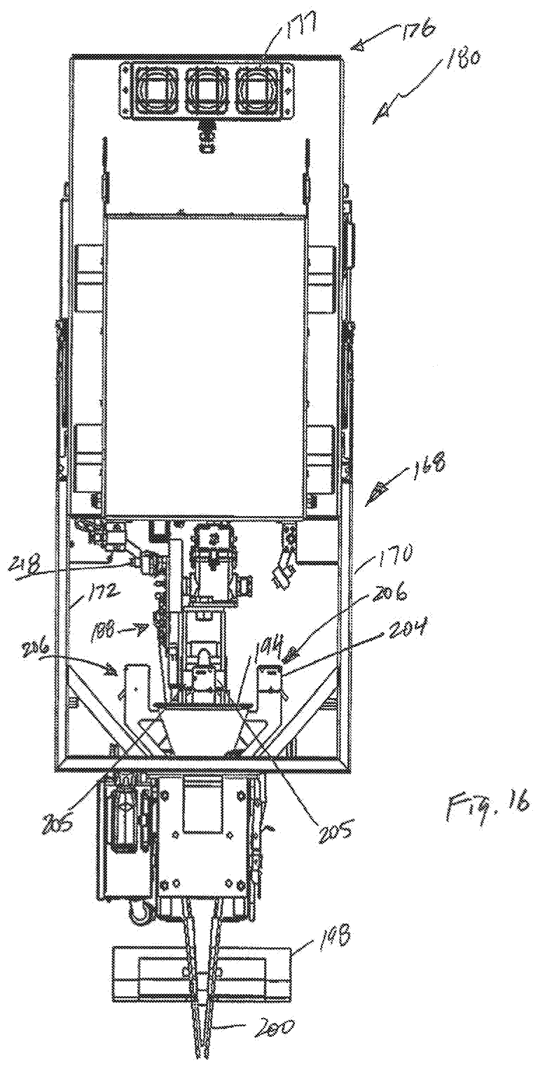

FIG. 16 shows a rear view of the mechanical transplanter 180 with the grabbers 188, 190 in the same position as FIG. 14. This view better shows the sensor plate 204, sensor transmitters 205 and sensor receivers 206. In this view, the grabber 188 can be seen passing between the center post of the sensor plate 204 and the arm on the left which houses the sensor receiver 206. Also can be seen trigger 218 engaging the lever 216 near the top of left grabber 188.

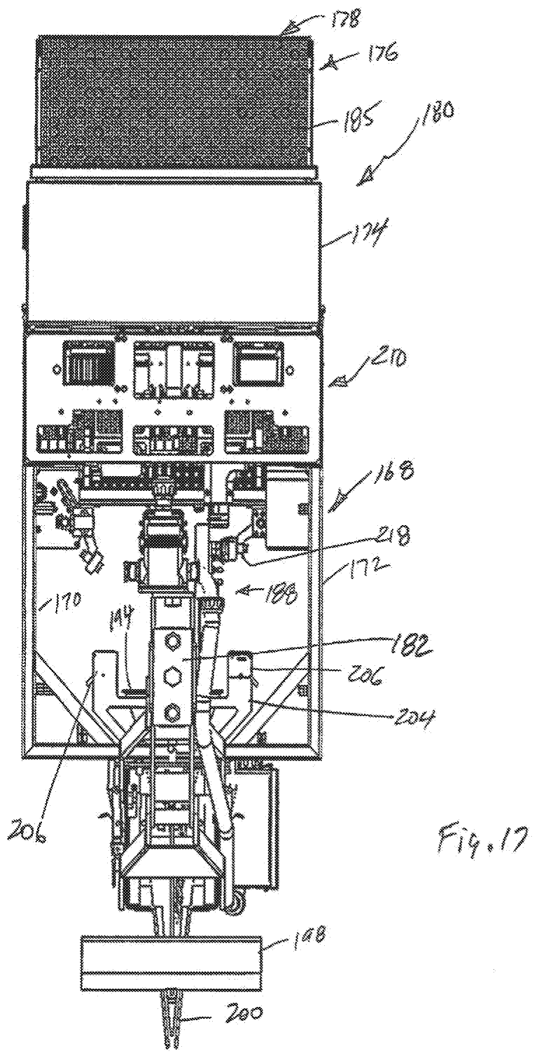

FIG. 17 shows a front view of the mechanical transplanter 180 with the grabbers 188, 190 in the same position as FIG. 14. In this view, the control box 174 is more clearly shown on top of the translation mechanism 210 and the plant balls 185 can be seen located in the tray 178 of the feeder 176.

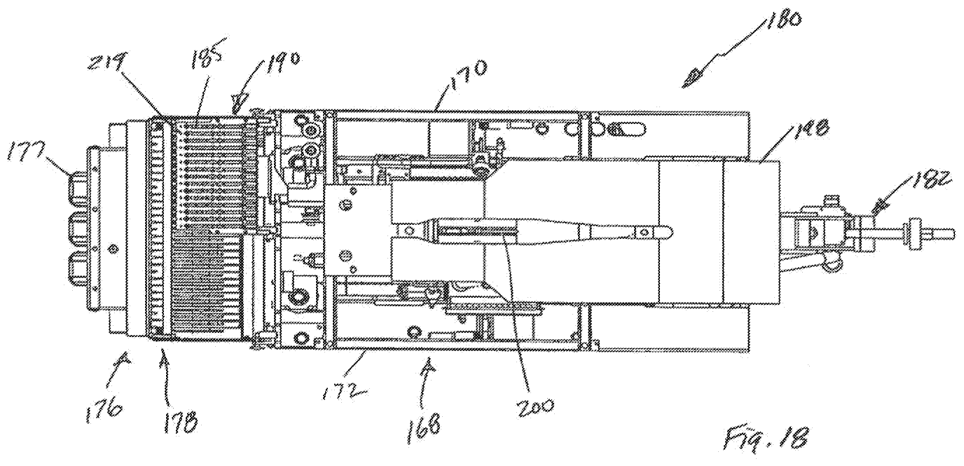

FIG. 18 shows a bottom view of the mechanical transplanter 180 with the grabbers 188, 190 in the same position as FIG. 14. Right grabber 190 can be seen snatching plant balls 185 from the tray 178 of feeder 176.

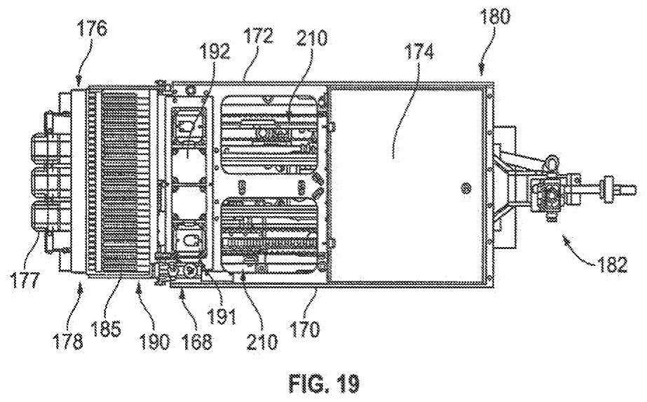

FIG. 19 shows a top view of the mechanical transplanter 180 with the grabbers 188, 190 in the same position as FIG. 14. In this view can be seen the grab motors 192 for operating the translation mechanism 210 and the grab controller 191 for interfacing with the feed motor 177 of the feeder 176 and control box 174. The control box 174 controls the logic and operation for the mechanical and electrical elements of the device.

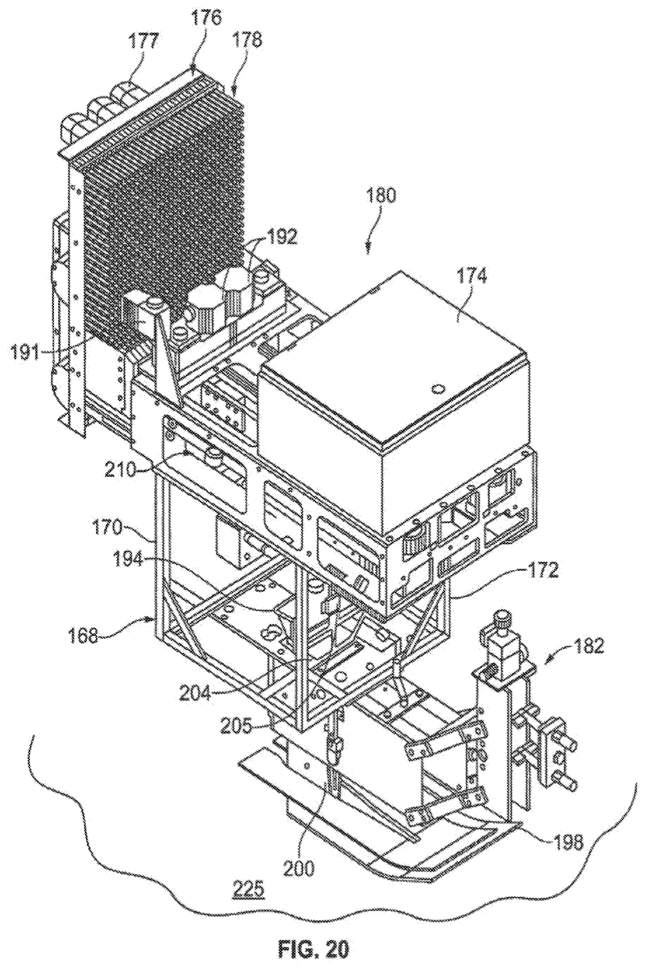

FIG. 20 shows a top front perspective view of the mechanical transplanter 180 with the grabbers 188, 190 in the same position as FIG. 14. The housing 168 has a left frame 172 and a right frame 170.

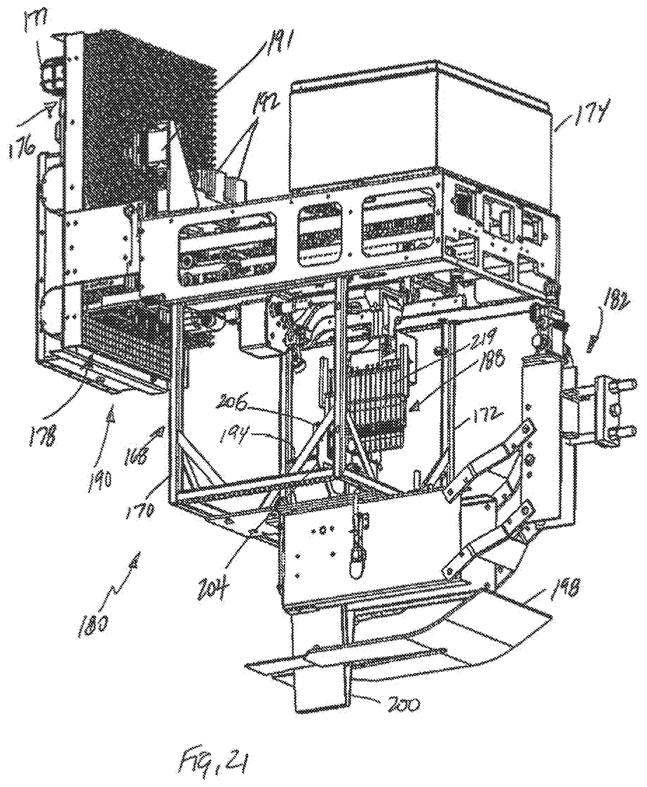

FIG. 21 shows a bottom right side perspective view of the mechanical transplanter 180. The left grabber 188 can be seen along with the sensor plate 204 and sensor receiver 206 for the right grabber 190.

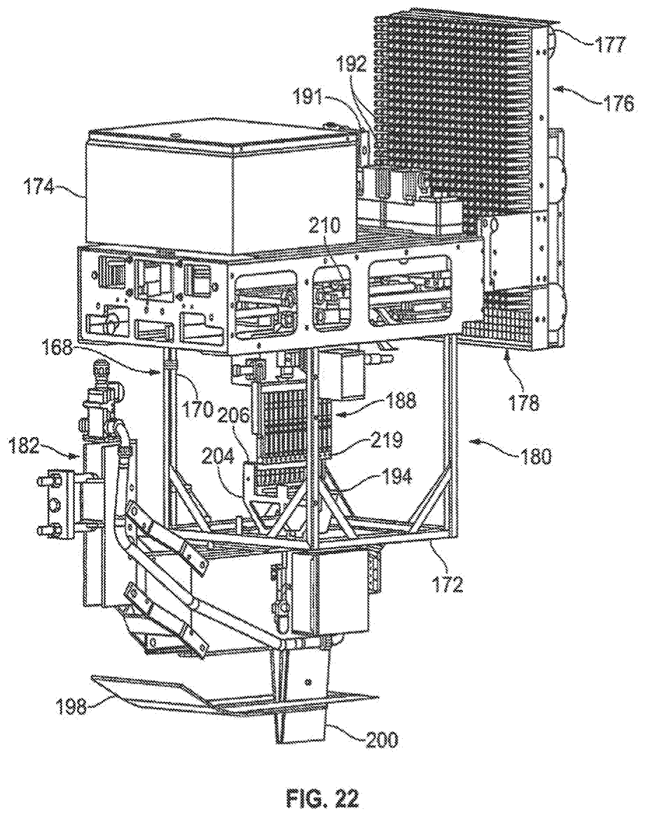

FIG. 22 shows a front left side perspective view of the mechanical transplanter 180. The left side of the left grabber 188 can be seen.

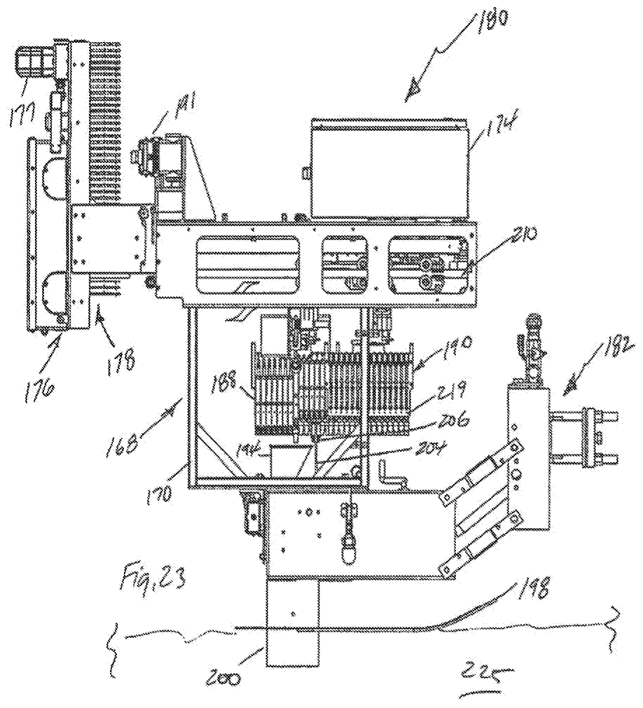

FIG. 23 shows a right side view of the mechanical transplanter 180. In this figure, the left grabber 188 is ejecting plant balls 185 and is near empty. The right grabber 190 has been reloaded with plant balls 185 and has been indexed between the sensor transmitter 205. The sensor transmitter 205 is located on the center post of the sensor plate 204 and the sensor receiver 206, is located on the post nearest the right frame 170 of the sensor plate 204. As right grabber 190 indexes, a signal is transmitted from the sensor transmitter 205 in the direction of the right frame 170 towards the sensor receiver 206. If the signal is blocked, then this indicates that there is a plant ball 185 loaded. If the signal is mostly clear, this can indicate a bad plant ball 185 or no plant ball 185. The logic in the control box 174 then knows that this position should be skipped when the right grabber 190 indexes to the ejection position so that a good plant ball 185 is ejected at the planting position.

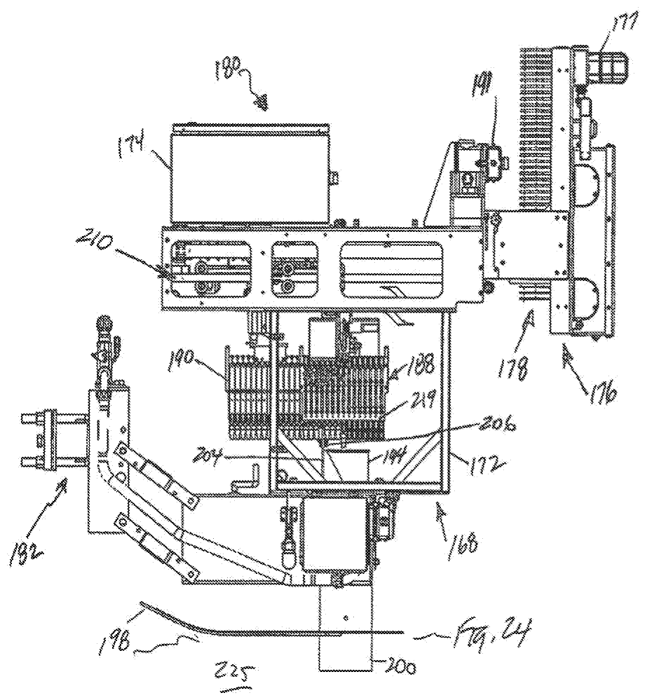

FIG. 24 shows a left side view of the mechanical transplanter 180. In this figure, the left grabber 188 is ejecting plant balls 185 into the funnel 194 and to the ground 225. The right grabber 190 has been reloaded with plant balls 185 and is waiting to eject.

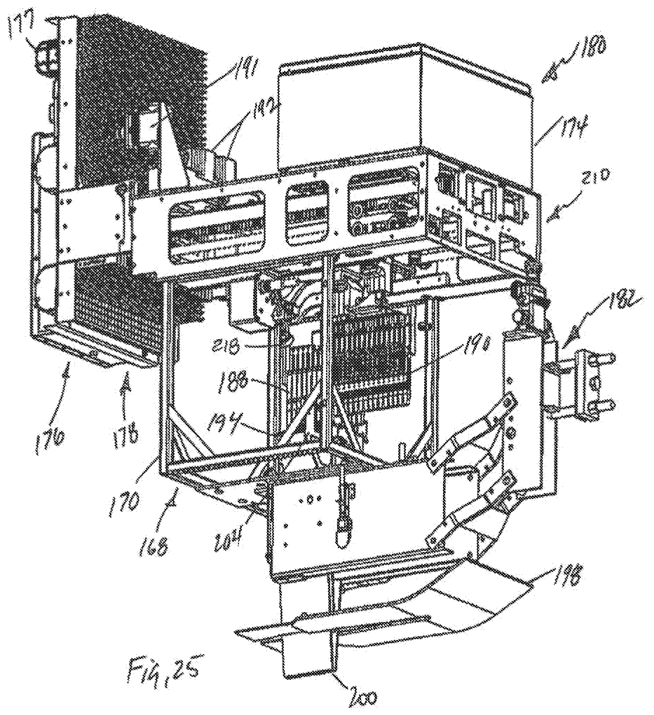

FIG. 25 shows a right side perspective view of the mechanical planter 180. In this figure, the left grabber is ejecting plant balls 185 into the funnel 194 and into the ground 225. The right grabber 190 has been reloaded with plant balls 185 and is waiting to eject.

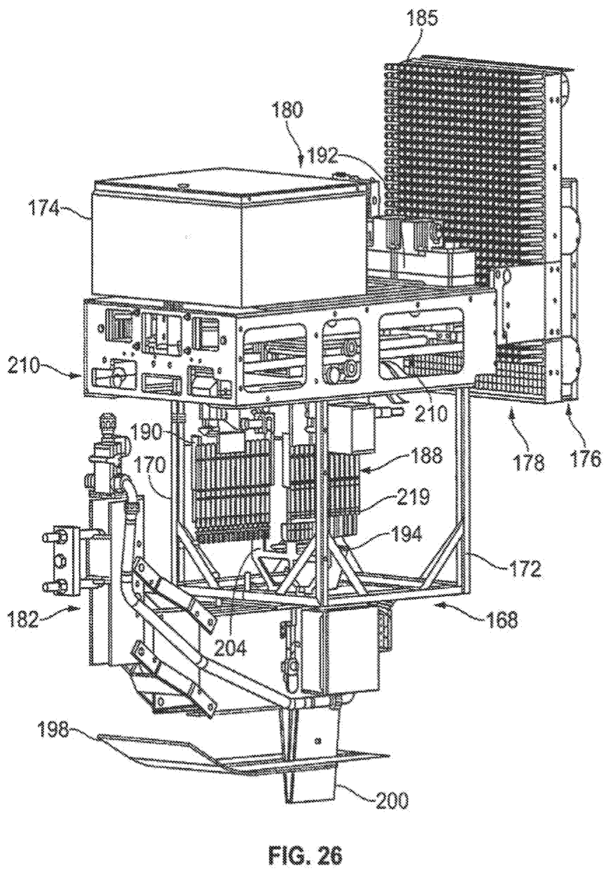

FIG. 26 shows a left side perspective view of the mechanical transplanter 180. In this view, the left grabber 188 is dispensing or ejecting plant balls 185 and the right grabber 190 has been loaded with plant balls 185 and is ready to begin dispensing or ejecting.

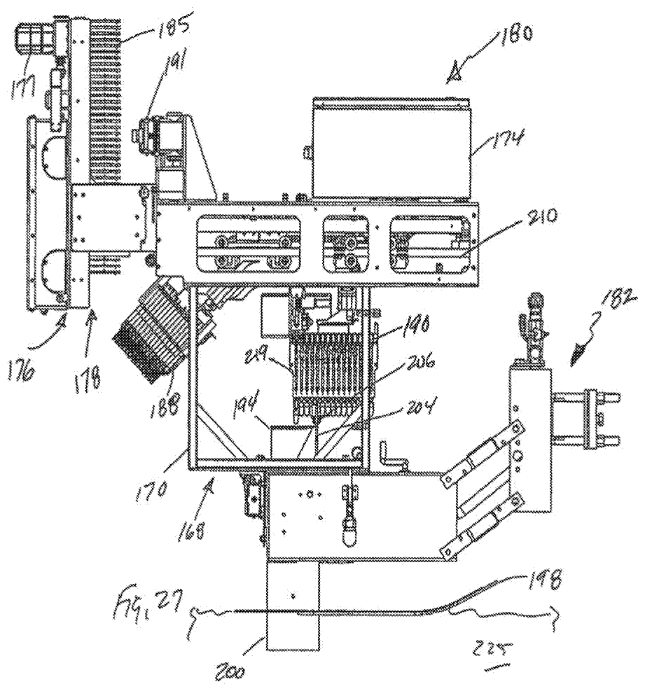

FIG. 27 shows a right side view of the mechanical transplanter 180. In this figure, the left grabber 188 has fully dispensed the plant balls 185 and is being translated towards the back of the transplanter 180 via the translation mechanism 210. As can be seen, the left grabber 188 is being rotated and translated such that it can engage the plant balls 185 and remove them from the tray 178 of the feeder 176. The right grabber 190 has indexed via the translation mechanism 210 over the funnel 194 and has begun ejecting the plant balls 185 into the funnel with force such that they are planted in the ground 225.

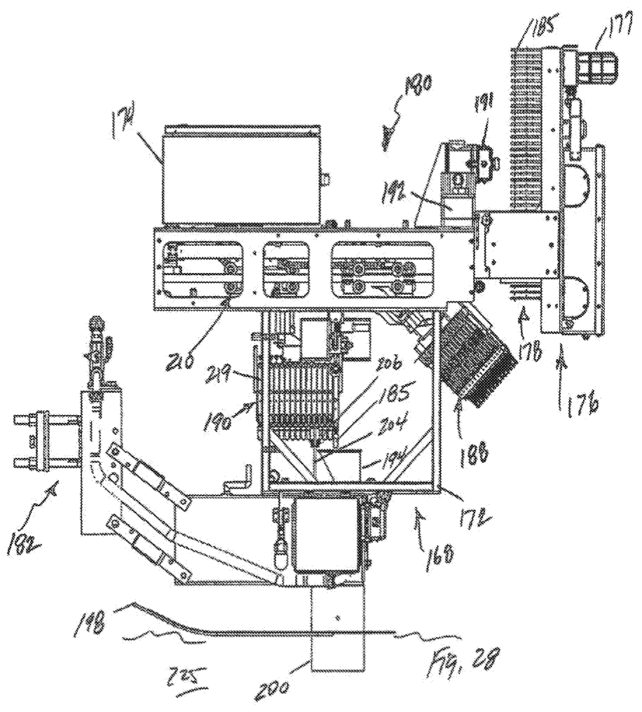

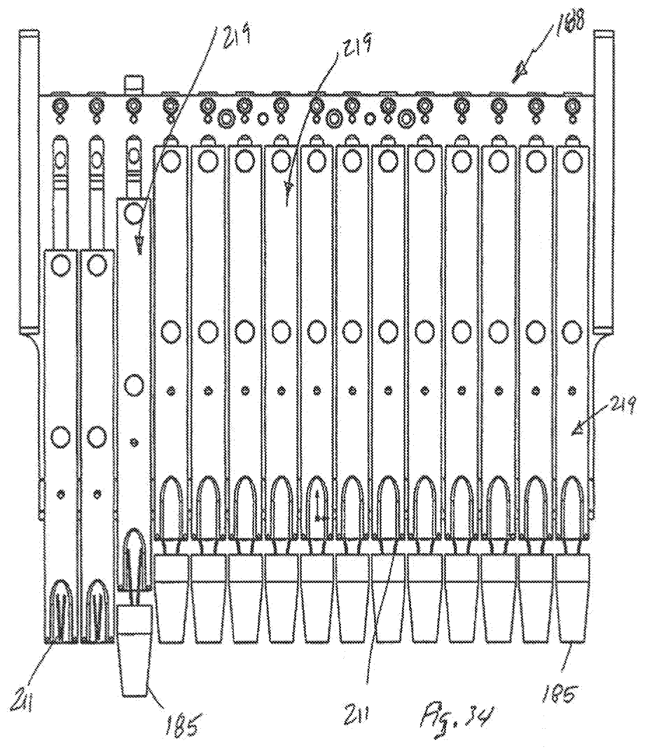

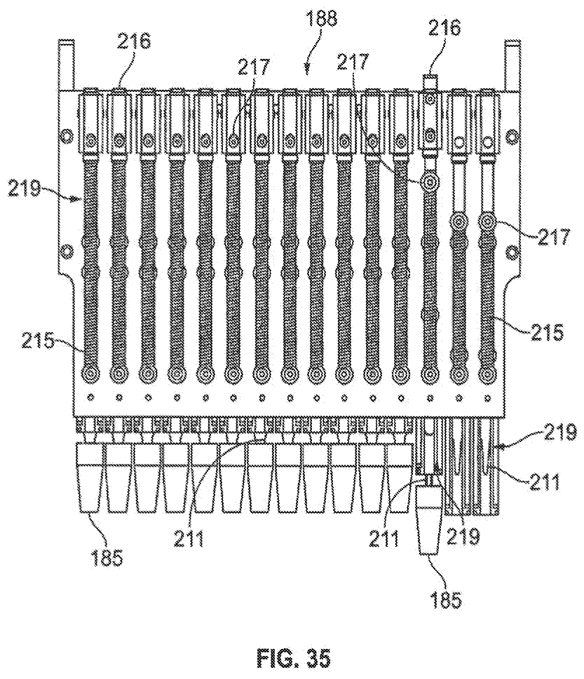

FIG. 28 shows a left side view of the mechanical transplanter 180. The left and right grabbers 188, 190 are located in the same positions as those of FIG. 27. In this view, one can see the plant ball 185 being ejected into the funnel 194 for planting into the ground 225. The left grabber 188 can also be seen as it is moving to the position for loading plant balls 185 and cocking or loading the springs 215 of the ejectors 219. The ejectors 219 are spring loaded mechanisms that have a lever 216 located near the top of the ejectors 219 and forks or tines 211 located near the bottom. A pin 217 is engaged with the lever 216 to load the springs 215 of the ejectors 219. When the plant ball 185 is ejected, the trigger mechanism 220 moves the trigger 218 to engage the lever 216 which releases the pin 217 from the lever 216 allowing the spring 215 to return to the no tension position which ejects the plant ball 185 from the ejector 219 and into the funnel 194, better show in FIGS. 34, 35.

While this embodiment uses a mechanical spring system to obtain and eject the plant balls 185 it should be understood that several other types of systems could be utilized such as electrical systems, pneumatic systems and others.

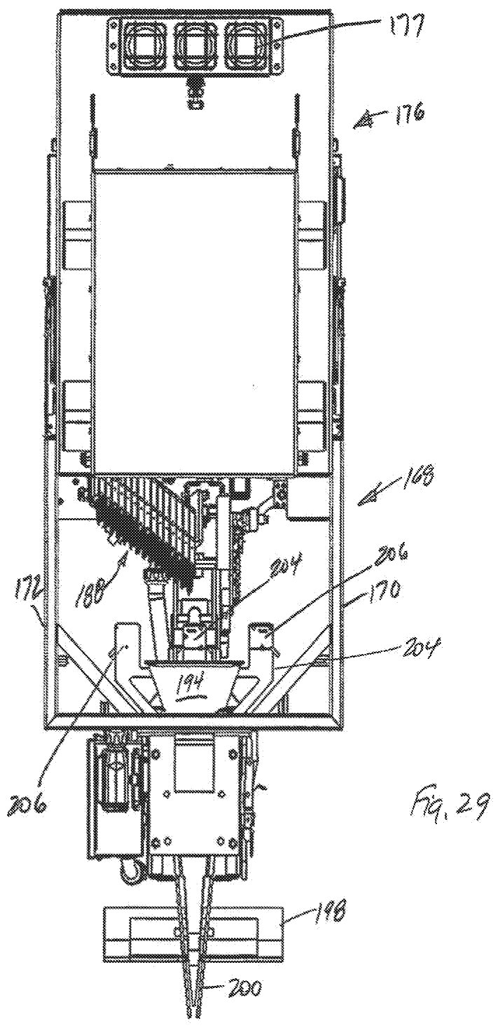

FIG. 29 shows a rear view of the mechanical transplanter 180. The grabbers 188, 190 are in the same position as those from FIG. 27.

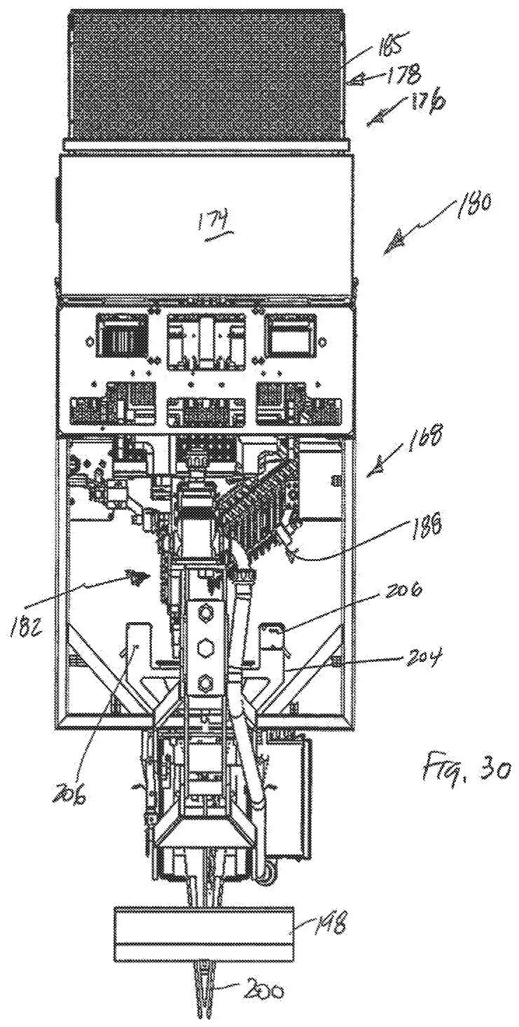

FIG. 30 shows a front view of the mechanical transplanter 180. The grabbers 188, 190 are in the same position as those from FIG. 27.

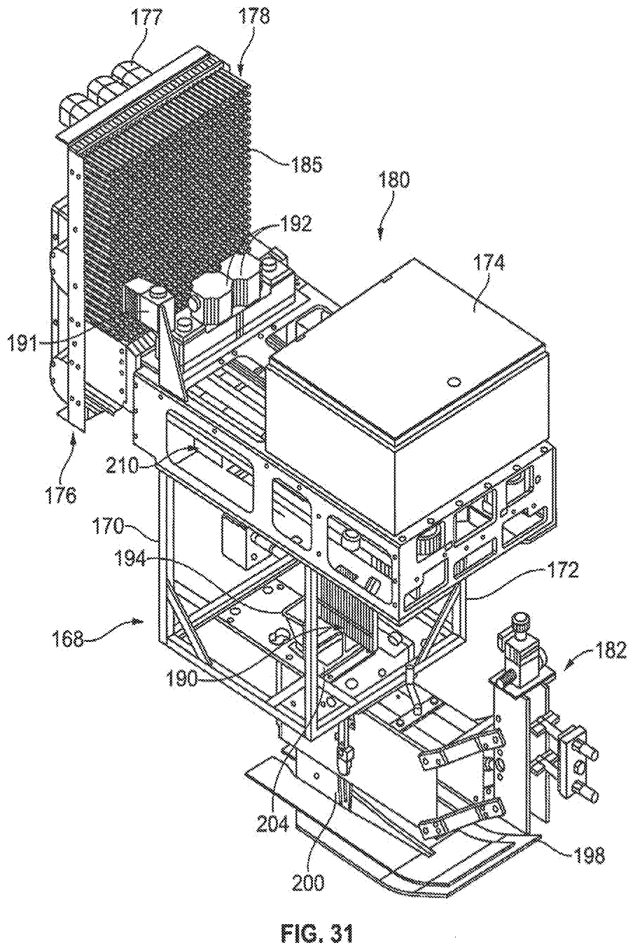

FIG. 31 shows a top front perspective view of the mechanical transplanter 180. The grabbers 188, 190 are in the same position as those from FIG. 27.

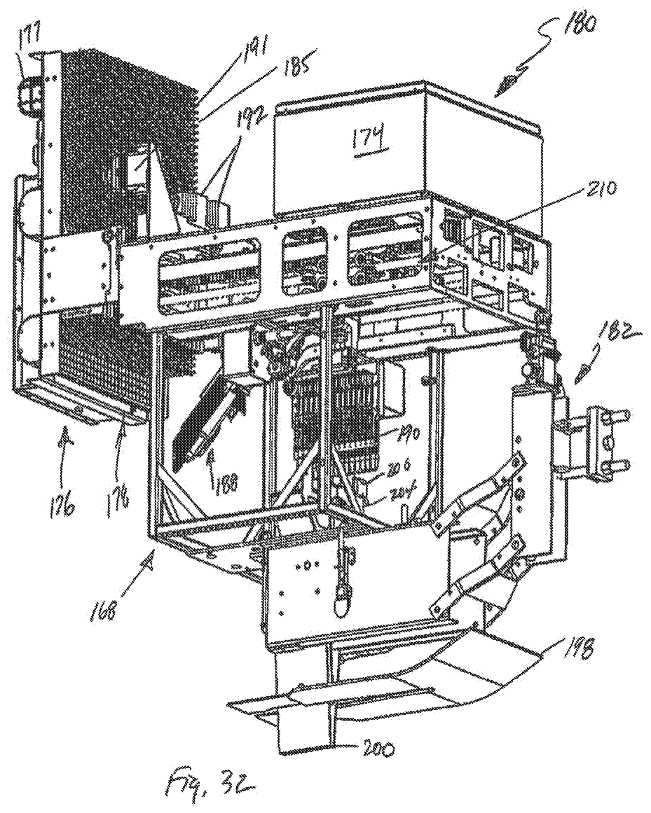

FIG. 32 shows a bottom right side perspective view of the mechanical transplanter 180.

The grabbers 188, 190 are in the same position as those from FIG. 27.

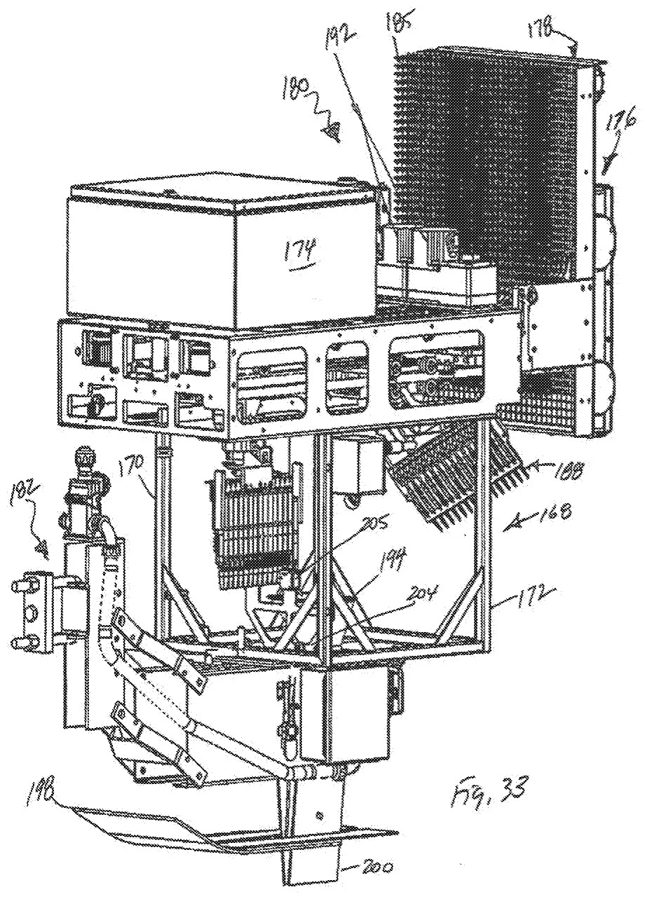

FIG. 33 shows a left front perspective view of the mechanical transplanter 180. The grabbers 188, 190 are in the same position as those from FIG. 27.

FIG. 34 shows a first side detailed view of left grabber 188, in this embodiment the left grabber 188 is used to discuss the operation of this device, but it should be understood that right grabber 190 is a mirror image of left grabber 188.

In FIG. 34 can be seen the plant ball 185 affixed to the ejectors 219. The ejectors 219 are affixed to the left grabber 188. FIG. 34 shows that two of the plant balls 185 have been ejected and a third plant ball 185 is in the process of being ejected by the ejector 219.

FIG. 35 shows the second side of the left grabber 188 from FIG. 34. As can be seen, the plant ball 185 is almost ejected from the ejector 219 as the spring 215 is being released from the lever 216 near the top of the left grabber 188. In this figure the springs 215 on the right of the grabber 188 are shown in a loose or relaxed position. This indicates that these springs 215 for these ejectors 219 have been unloaded and the plant balls 185 have been fully ejected. The third ejector 219 from the right in this figure is only partially unloaded and the plant ball 185 is partially ejected.

The springs 215 to the left of the partially ejected plant ball 185 are fully extended or loaded and affixed to the pin 217 and retained by the lever 216. To get from the loaded spring 215 position to the unloaded spring 215 position requires the trigger mechanism 220 trigger 218 to engage with the lever 216, causing the lever to rotate and when doing so, disengaging the pin 217 from the lever 216. The pin 217 retains one end of the spring 215. When the lever 216 is rotated by the trigger 218, the pin 217 is released and the spring 215 is free to compress or release which ejects the plant ball 185 from the tines 211 of the ejector 219 and into the funnel 194 the shoe 200 and thereby forcefully into the ground 225.

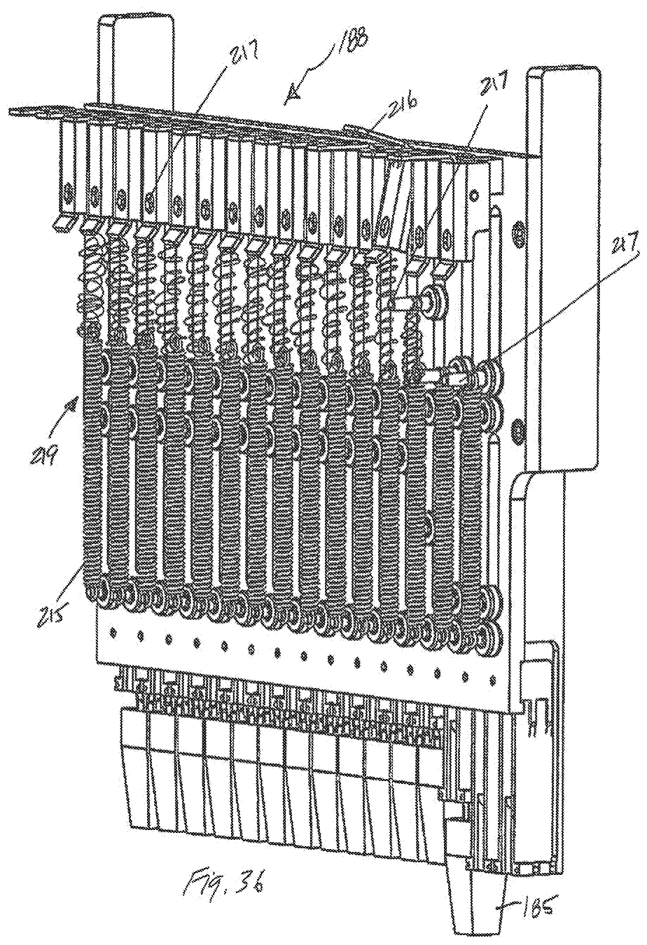

FIG. 36 shows one side of the left grabber 188 where it can be more clearly seen the interaction of the pin 217, spring 215 and lever 216. It should be noted that the right two springs 215 are in the fully relaxed position, the third spring 215 from the right is in a partially relaxed position and the springs 215 to the left of the third spring from the right are fully extended or loaded position.

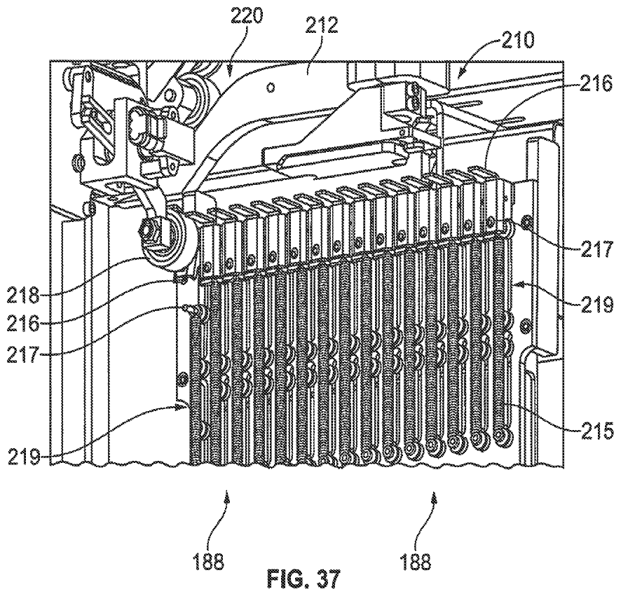

FIG. 37 shows a side view of an example of the left grabber 188 and the interaction with the trigger mechanism 220 and trigger 218. It should be noted that only the left most spring 215 is partially released position, the springs 215 to the right of this are in the fully extended or loaded position.

As can be seen the ejector 219 has had the pin 217 released from the lever 216 by the trigger 218 pressing on the lever 216 causing the lever 216 to rotate and thereby releasing the pin 217 such that the spring 215 compresses and ejects the plant ball 185 from the tines 211 of the ejector 219 and into the funnel 194, some elements not shown this fig.

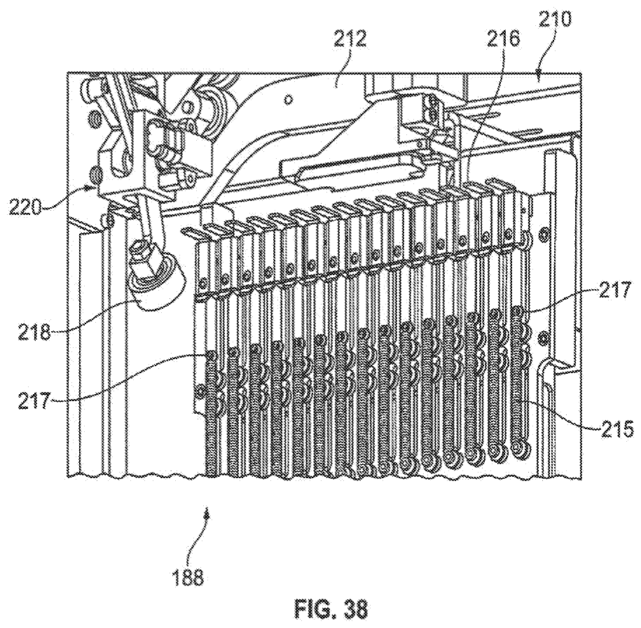

FIG. 38 shows the same side view of an example of the left grabber 188 where the trigger 218 is in the clearance position. The clearance position is used when the grabber 188 is fully loaded and it is passing through the arms of the sensor plate 204 such that the sensor transmitter 205 and sensor receiver 206 can “read” to see if plant balls 185 are loaded before ejection into the funnel 194.

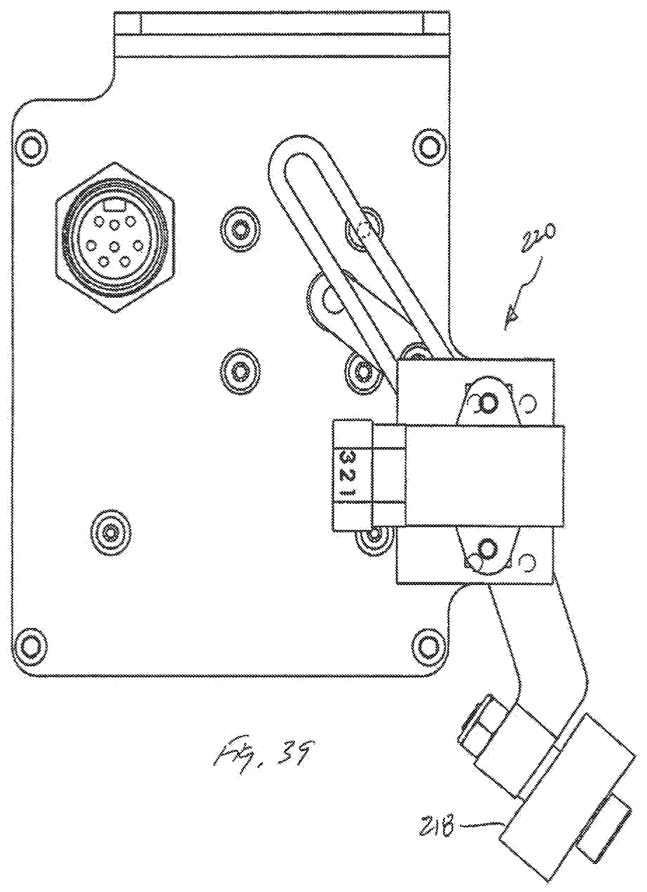

FIG. 39 is a detailed side view of one embodiment of the trigger mechanism 220 with the trigger 219 in the unloaded position.

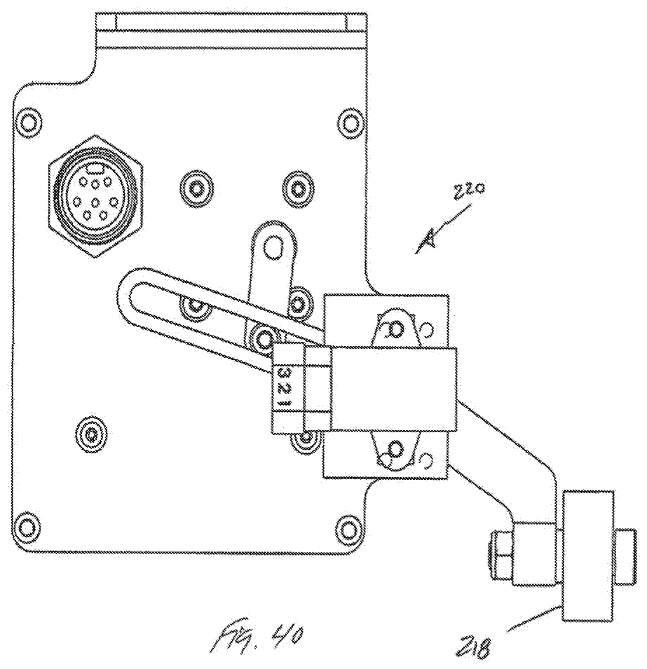

FIG. 40 is a detailed side view of one embodiment of the trigger mechanism 220 with the trigger 219 in the releasing position.

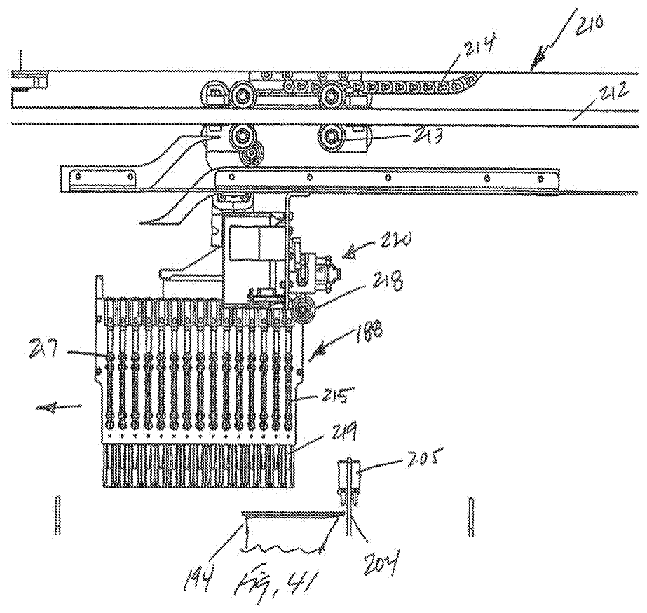

FIG. 41 shows a side cutaway view of the left grabber 188 and interaction between the sensor plate 205 sensor transmitter 205, translation mechanism 210, trigger mechanism 220 and trigger 219. In this view, the grabber 188 has completed ejecting plant balls 185 forcefully into the funnel 194 and is returning to the loading position adjacent to the feeder 176, not show.

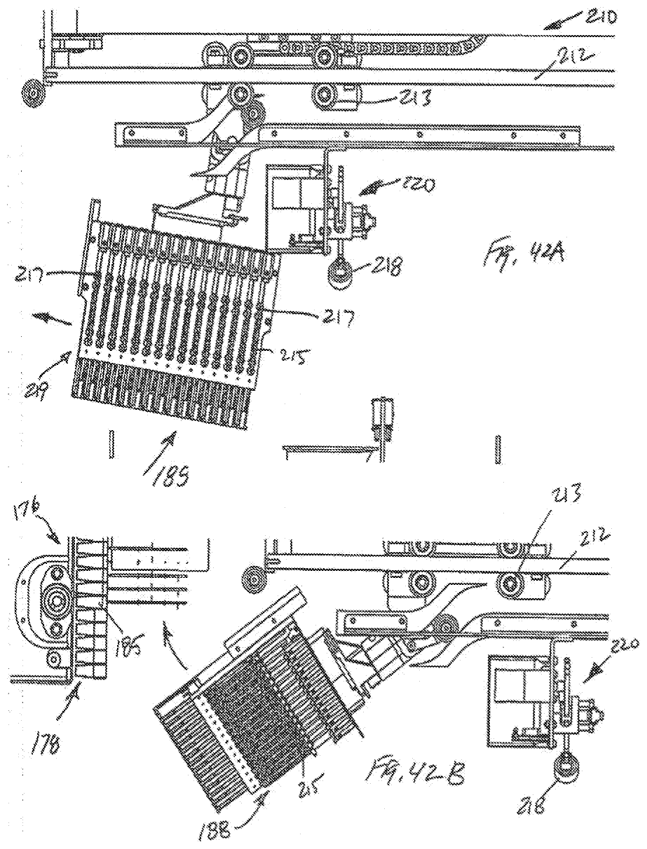

FIG. 42A shows a side cutaway view of the left grabber 188 as it begins to rotate from a primarily vertical position to a horizontal position.

FIG. 42B shows a side cutaway view of the left grabber 188 as it get closer to the horizontal position near the feeder 176.

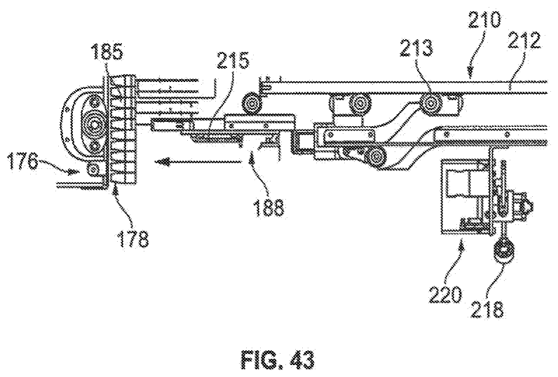

FIG. 43 shows a side cutaway view of the left grabber 188 as it engages the feeder 176 to grab plant balls 185. As the left grabber 188 is pushed against the tray 178 the tines 211 engage the root ball of the plant ball 185 and as they do so, the ejector 219 is pushed into the grabber 188 such that the pins 217 of each ejector 219 translate to the lever 216, causing the lever 216 to rotate and pin 217 to become engaged in the lever 216. The spring 215 is in the extended or loaded position at this point. As this is completed, the plant ball 185 is engaged by the tines 211 of the ejector 219, the pin 217 is engaged in the lever 216 and the grabber 188 is ready to rotate and translate back to near the funnel 194 for ejection of the plant balls 185.

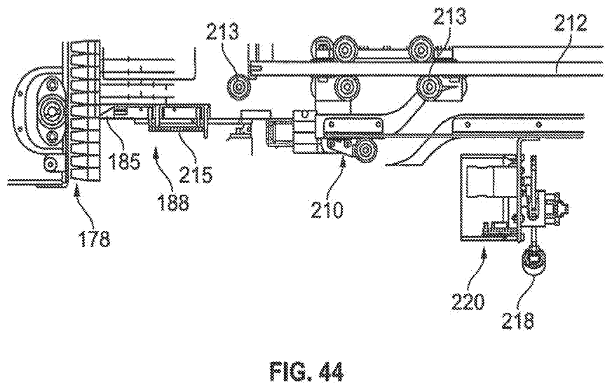

FIG. 44 shows the grabber 188 in the fully engaged position such that the ejectors 219 are loaded with plant balls 185 and springs 215 are fully extended.

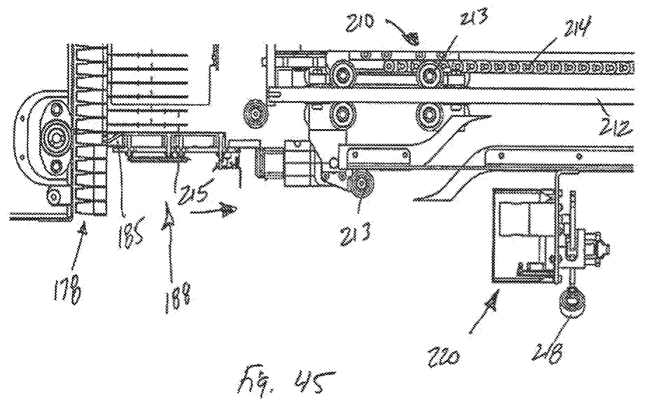

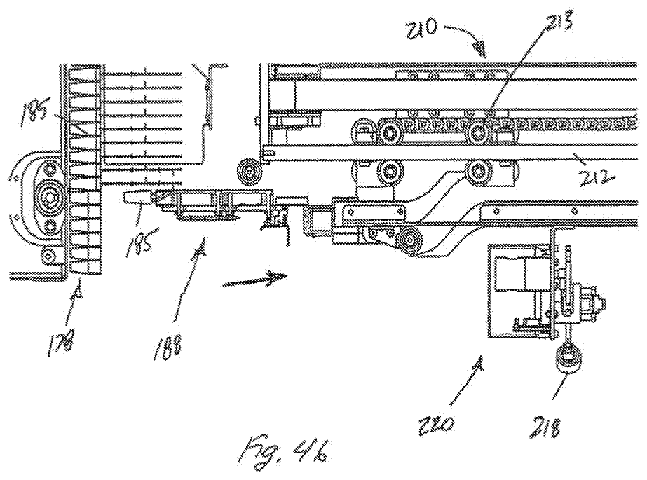

FIG. 45 shows the grabber 188 as it is being translated from near the feeder 176. FIG. 46 shows the grabber 188 further from the feeder 176 position.

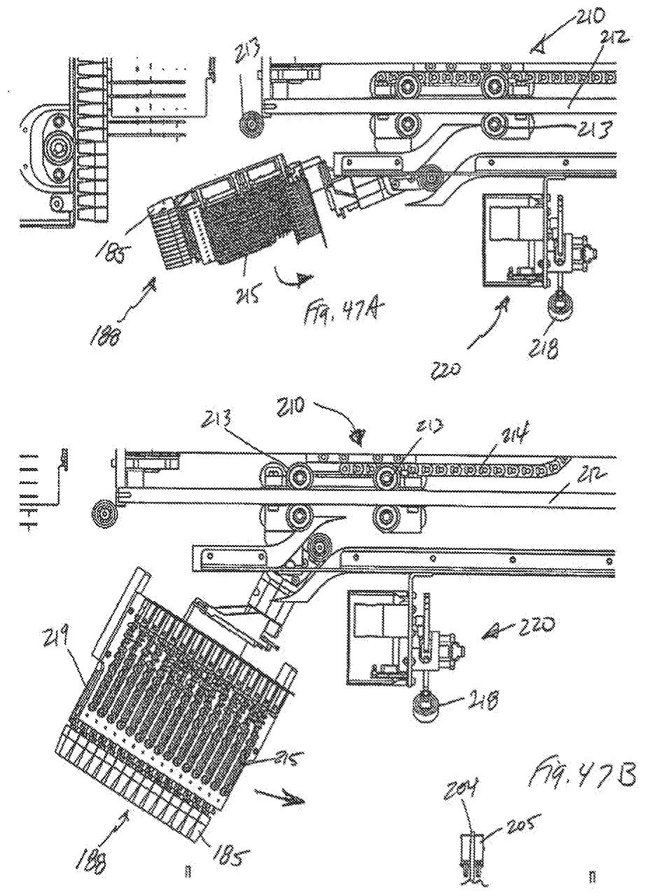

FIG. 47A shows the grabber 188 as it begins to rotate from the horizontal position to the vertical position.

FIG. 47B shows the grabber 188 as it gets closer to the vertical position.

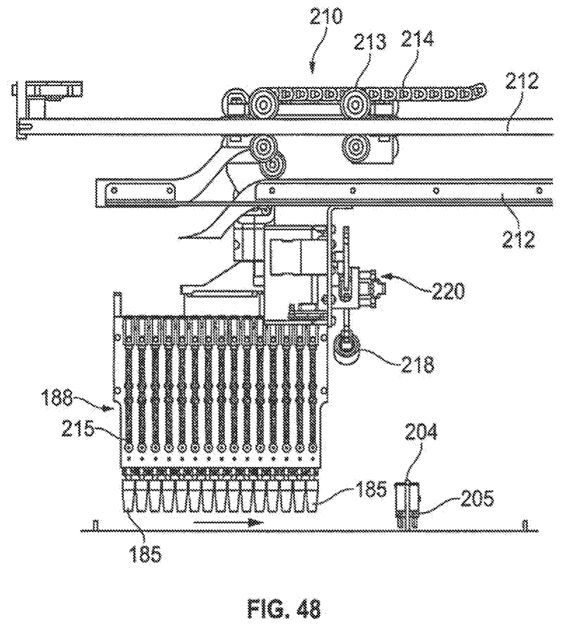

FIG. 48 shows the grabber 188 in the fully vertical position as it get close the sensor plate 204 so that the sensor transmitter 205 and sensor receiver 206 can sense if a plant ball 185 was engaged and so report to the control box 174.

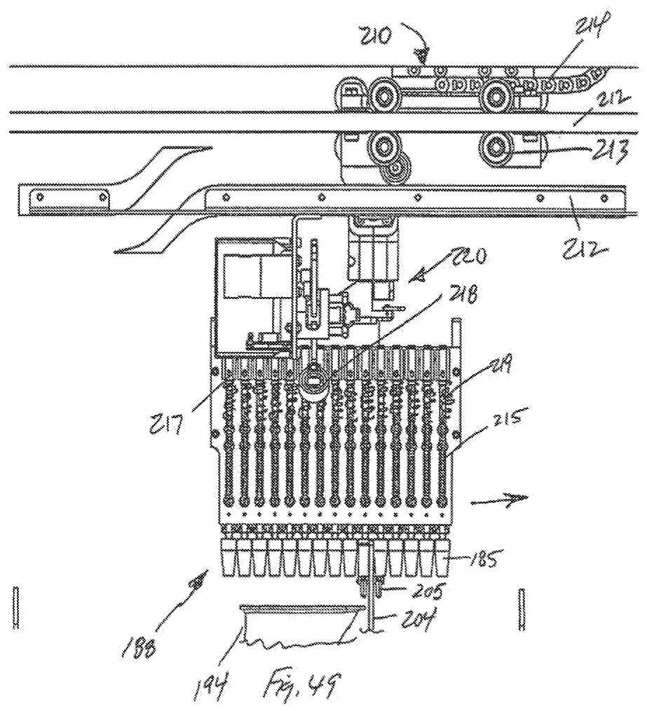

FIG. 49 shows the grabber 188 and plant balls 185 passing between the sensor transmitters 205 and sensor receiver 206 of the sensor plate 204 and inspecting for complete plant ball 185 engagement.

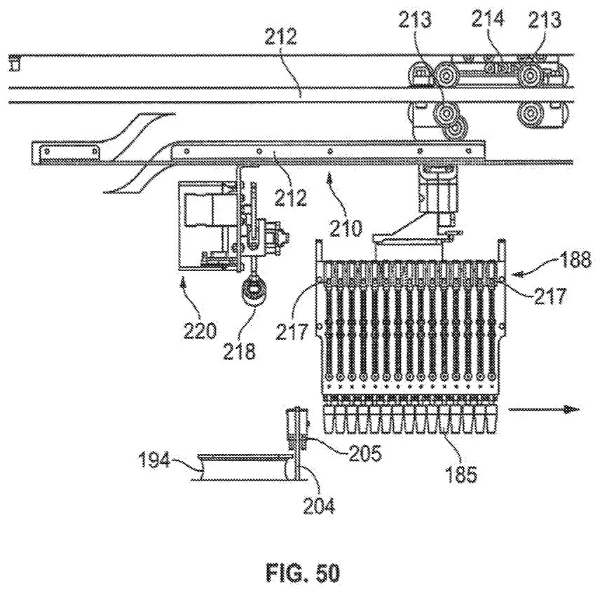

FIG. 50 shows the grabber 188 and plant balls 185 post inspection by the sensor transmitter 205 and sensor receiver 206. In this position, the logic recognizes if there is or if there is not a plant ball 185 on the tines 211 of the ejector 219 and will adjust the position of the grabber 188 over the funnel 194 so that a plant ball 185 is ejected from the ejector 219 at the proper timing to then be forcefully ejected into the funnel 194 and ground 225.

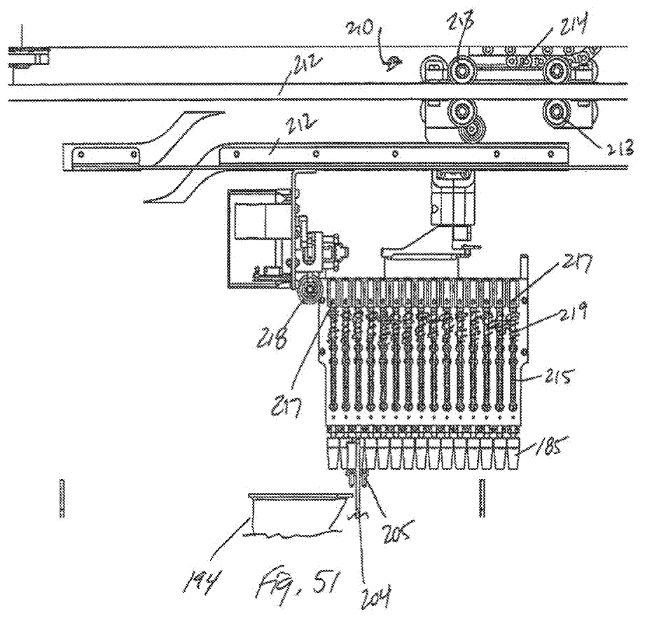

FIG. 51 shows the grabber 188 and plant balls 185 translating towards the funnel 194 where the trigger 218 is getting close to engaging the lever 216 of the ejector 219. When the trigger 218 engages the lever 216 this causes the lever 216 to rotate, disengaging the pin 217 from the lever 216, releasing the spring 215 and causing the plant ball 185 to be ejected from the ejector 219 into the funnel 194 and the ground 225.

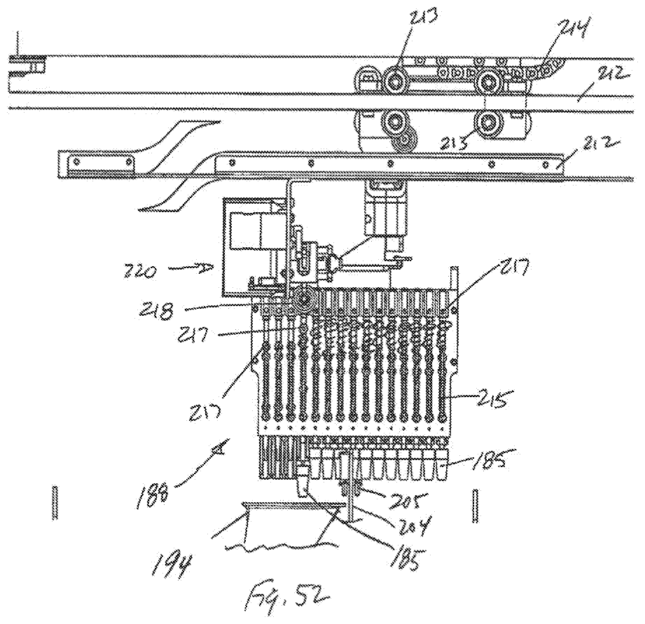

FIG. 52 shows the grabber 188 has ejected two plant balls 185 and is continuing to index via the translation mechanism 210 to forcefully eject more plant balls 185 into the funnel 194.

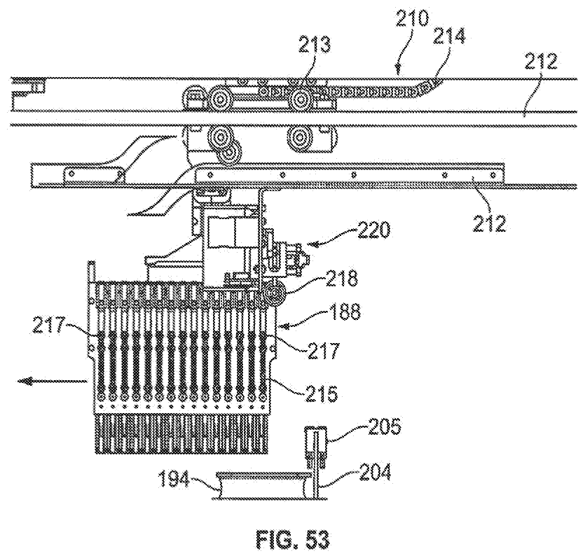

FIG. 53 shows the grabber 188 fully unloaded and ready to be refilled with plant balls 185.

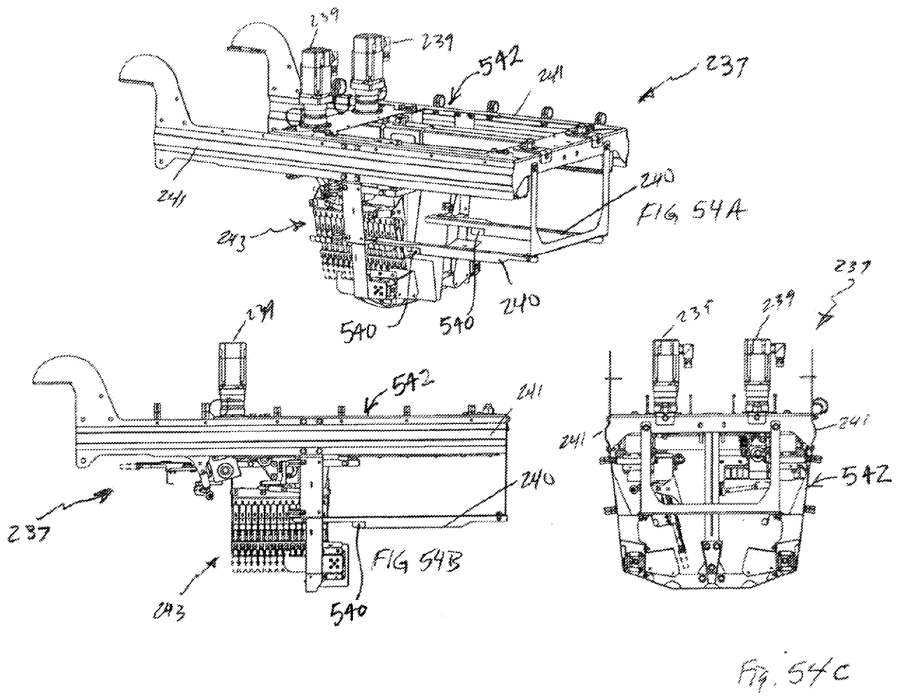

FIG. 54A shows a right side perspective view of another embodiment of a plant dispensing unit 237. The skilled artisan will understand that while the term “unit” is utilized herein to indicate that the various unit components and elements work together and are coordinated as one cohesive, coordinated unit, the planting “unit” is also considered to be a planting system, i.e. comprising multiple coordinated elements, modules, and/or devices.

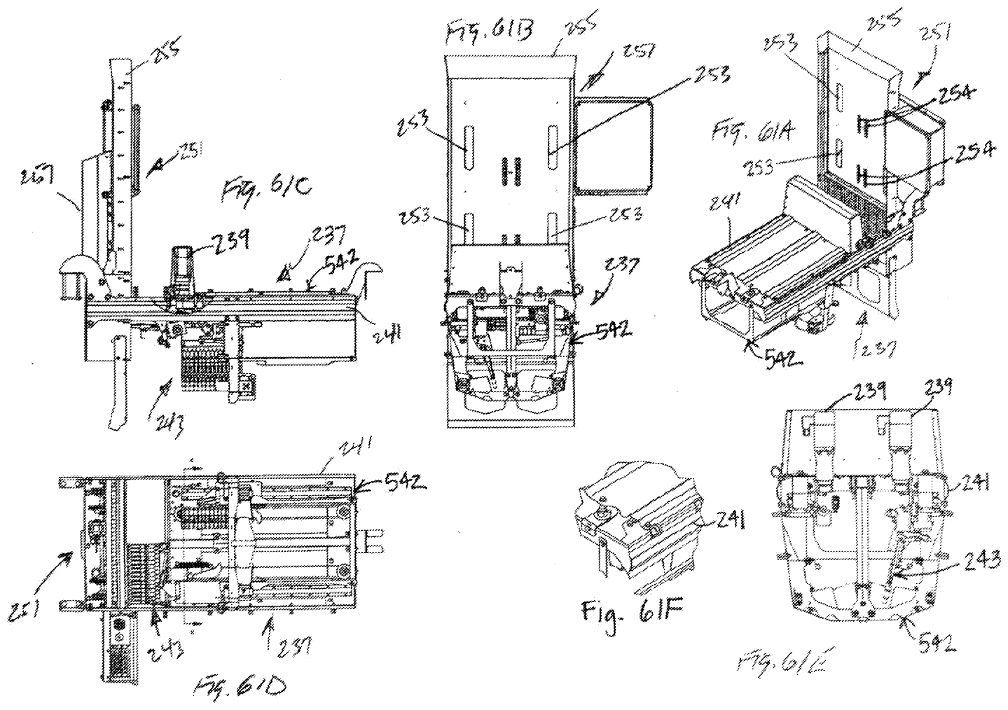

Dispensing unit 237 includes dispensing unit frame 542, to which the other dispensing unit elements are coupled. The dispensing unit frame 542 in some embodiments is coupled to the flat feeder 251 (as shown in FIGS. 61A-61D). This dispensing unit 237 has a pair of drive rails 241 on each side of the unit 237. Two ejector drive systems 239 are located on the top of the unit 237. The ejector drive systems 239 are interconnected to the ejector assemblies 243, one ejector drive system 239 powers one ejector assembly 243. The ejector assemblies 243 translate from a first position to a second position along the drive rails 241. The ejector assemblies 243 have several components and are used to grab plants from trays, rotate and translate the plants to the proper position and shoot or eject the plants for planting as has been explained previously. A release bar trigger 240 is also shown for indicating when the ejector assembly 243 should eject the plant ball 185. The release bar trigger 240 includes fixed/stationary trigger tab 540, which interacts with the release tab 249 of each ejector to release the spring 246 and eject the plant ball 185. As

This embodiment also shows a camera 277 with sensor 278. The camera 277 and sensor 278 can be used in conjunction with an IR source (not show). The IR source indicates to the camera 277 and sensor 278 that there is a plant ball 185 on the tines 108 of the fork 92. If the sensor 278 shows a plant ball 185, the ejector 267 ejects the plant ball 185 with force into the funnel 264 of the funnel assembly 268 of the planting shoe mechanism 263 and ultimately into the soil or ground. If the IR source and sensor 278 do not read the presence of a plant ball 185, the unit quickly indexes until the sensor 278 receives a positive IR signal that a plant ball 185 is present. By checking for the presence of plant balls 185, the unit 237 can save time by quickly indexing to the next plant ball position and eject the next plant ball 185 fast enough so that a plant ball 185 is still planted at the next regularly coordinated time. That is, instead of the ejector 267 ejecting without a plant ball 185 using the regular timing and the shoe drive system 265 then operating the kicker assembly 652 at the coordinated time but without a plant ball 185 to plant, the ejector drive system 239 indexes the ejector assembly 243 quickly through the empty ejector(s) position(s) and to the next ejector 267 with a plant ball 185 so that the next ejector 267 with a plant ball 185 arrives at the location for ejection at the next coordinated time and therefore the shoe drive system 265 is still operating the kicker assembly 652 to plant a plant ball 185 at the coordinated time. The ejector assembly 243, sensor system, ejector drive system 243 and control system 6805 are configured to move through up to and including four empty ejectors 267 and still have the next ejector 267 with plant ball 185 be in place at the next regular coordinated time. The ability to detect the missing plant balls 185, communicate that information to the control system 6805, vary the speed of the ejector assembly 243, and move the ejector assembly 243 at very fast speeds is therefore advantageous for increasing the number of plant balls 185 that can be ejected in a given time period and significantly improving efficiency.

This embodiment simplifies the number of components, accuracy and speed with which the plants are grabbed from the trays and ejected with force into the funnel 264 of the shoe 200 and thereby into the ground/soil (not shown).

FIGS. 54B and 54C show additional views of the embodiment shown in FIG. 54A.

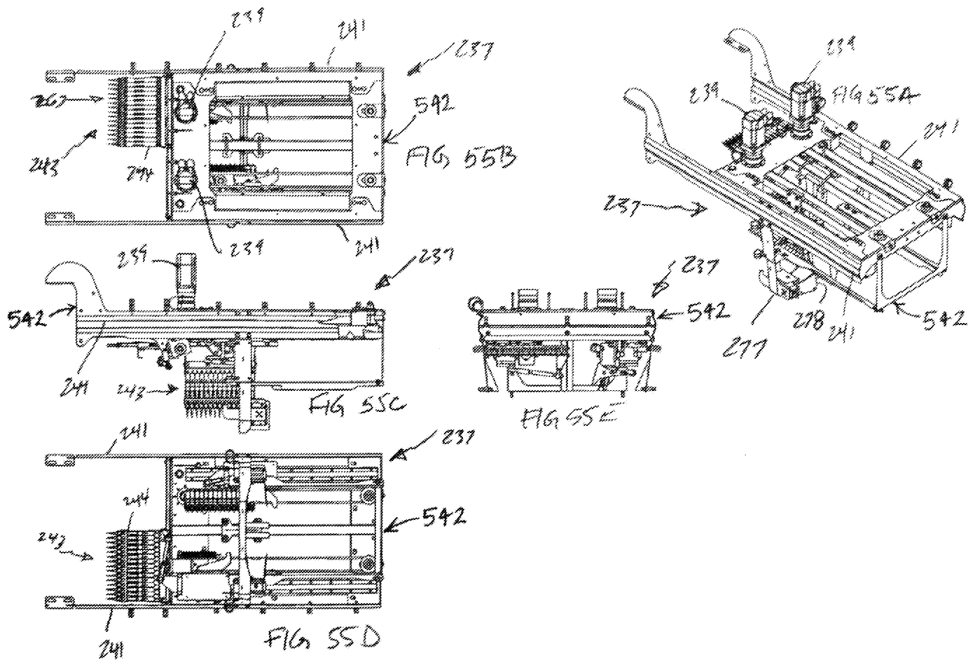

FIG. 55A shows another right side perspective view of the dispensing unit 237. The ejector assembly 243 can be seen in two positions, one in FIG. 55B and a second position shown in FIG. 55C.

This embodiment also shows a camera 277 with sensor 278. The camera 277 and sensor 278 can be used in conjunction with an IR source (not shown). The IR source indicates to the camera 277 and sensor 278 that there is a plant ball 185 on the tines 108 of the fork 92. If the sensor 278 shows a plant ball 185, the ejector 267 ejects the plant ball 185 with force into the funnel 264 of the funnel assembly 268 of the planting shoe mechanism 263 and ultimately into the soil or ground. If the IR source and sensor 278 do not read the presence of a plant ball 185, the unit quickly indexes until the sensor 278 receives a positive IR signal that a plant ball 185 is present. By checking for the presence plant balls 185, the unit can save time by not ejecting where there is no plant ball 185 present, index to the next plant ball position and eject plant balls 185 faster thereby increasing the number of plant balls 185 that can be ejected in a given time period and significantly improving efficiency.

The embodiment shown in these figures benefits from only a single ejector drive system 239 per ejector assembly 243. Each ejector drive system 239 can control the movement of a single ejector assembly 243 accurately and quickly. This embodiment allows the plant balls 185 to be indexed into position proximate to the funnel 264. Once the plant balls 185 are indexed to the proper position, they are ejected with force into the funnel 264 and thereby into the ground (not shown).

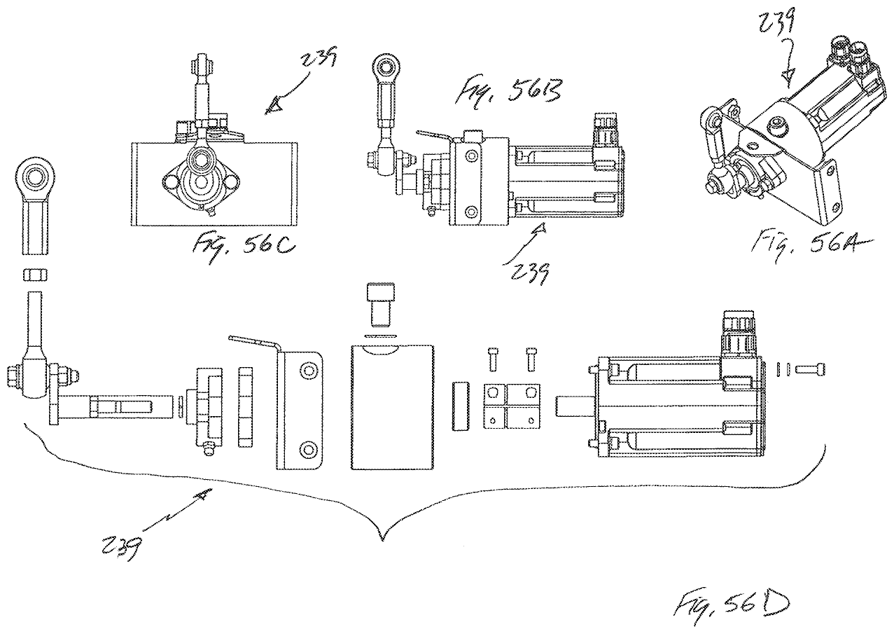

FIG. 56A shows a top perspective view of another embodiment of the ejector drive system 239 and linkage of a the ejector drive system 239 and related components. FIGS. 56A-56D show various views of this ejector drive system 239 and components and how they are interconnected. The ejector drive system 239 in some embodiments includes an electric motor and a drive. In some embodiments the electric motor is a servo motor. In some embodiments the ejector drive system 239 includes an integrated encoder.

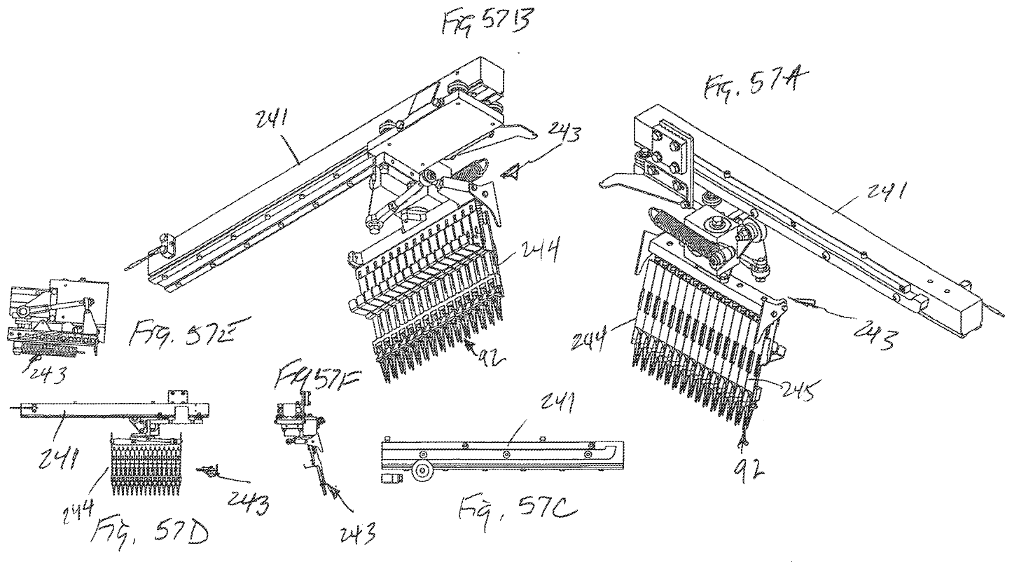

FIG. 57A shows a perspective view of a drive rail 241 with an ejector assembly 243 affixed. To obtain plant balls 185 for ejection, the ejector assembly 243 fork 92 tines 108 are inserted into plant balls 185 in the trays 43 of the flat feeder 251. A full row of plant balls 185 is obtained and translated horizontally from the flat feeder 251 to a release point near the funnel 264 and ejected with force into the planting shoe mechanism 263 and ultimately into the ground. Each plant ball 185 is ejected with force at exactly the same position in the funnel 264.

An infrared laser (IR) and sensor 278 is used to check that the ejector assembly 243 fork 92 tines 108 contain a plant ball 185. If tines 108 do not contain a plant ball 185, then indexing to that position does not occur and is skipped to the next position where the tines 108 do contain a plant ball 185.

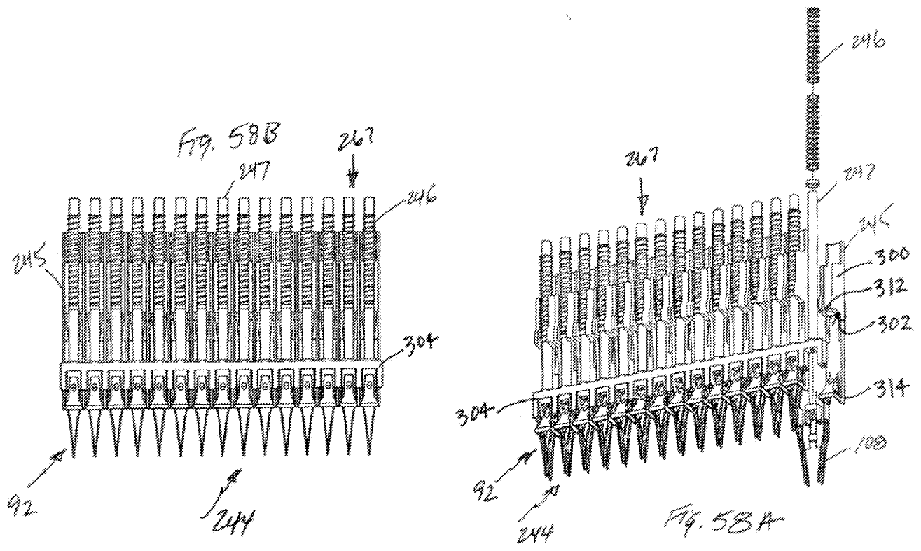

FIGS. 58A and 58B show two views of the ejector assembly housing 244 and related components. The ejector assembly 243 ejects the plants into the funnel 264 with force thereby getting the plants into the ground as quickly and accurately as possible. The tines 108 of the fork 92 secure the plant ball 185 from the tray and are loaded with spring 246.

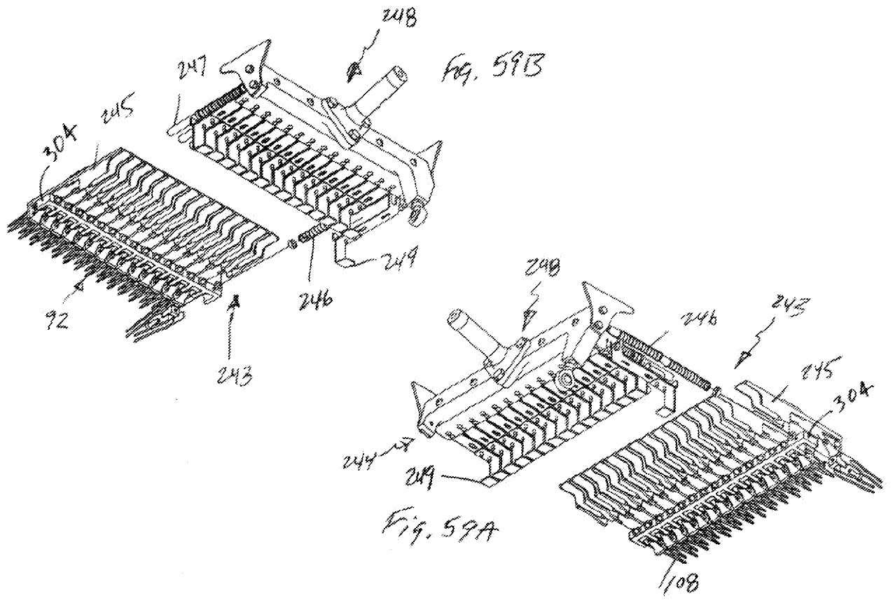

FIGS. 59A and 59B show two views of the ejector assembly 243 and related components affixed to an arm 248. The arm 248 interconnects with components coupled to of the ejector drive system 239 and the drive rails 241. Also shown in these exploded views are other components of the ejector housing 244 and how they interconnect.

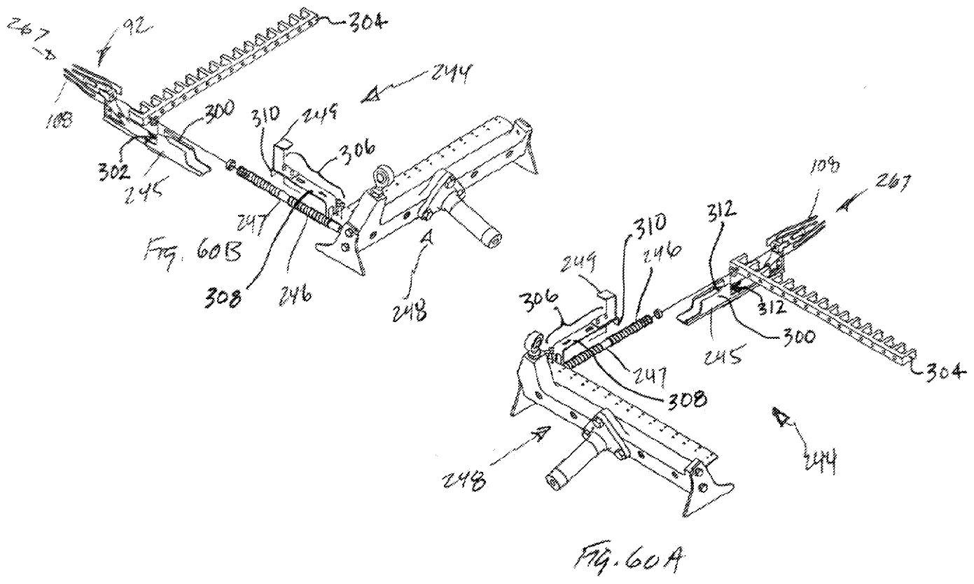

FIGS. 60A and 60B show different views of the arm 248 connected to one plant ejector 267 with some of the components such as a fork 92 with tines 108, plunger housing 245, spring 246 and shaft 247 that make up a single ejector 267. Also shown is a release tab 249 and tine 108 of the fork 92.

The ejector release mechanism for each plant ejector 267 is shown in FIGS. 59A-B and FIGS. 60A-B. The plant ejector comprises the shaft 247 encased by the spring 246. A top end of the shaft 247 and spring 246 are held in place by the ejector assembly housing 244. A bottom end of each shaft 247 is coupled to the beam 304. The release tab 249 is rotatably coupled to the shaft 147 at the top end of the shaft 247.

The plunger housing 245 includes a bracket 300 extending outward from a front side of the ejector 267. The plunger housing 245 is coupled to the shaft 247 for translation along the longitudinal axis of the shaft 247. The bracket 300 includes a bracket ledge 312 configured to retain a lower end of the spring 246. The bracket 300 also includes an underside surface 302. The bracket 300 and spring 246 are therefore integrated such that downward movement of the lower end of the spring 246 also pushes the plunger housing 245 downwards until either the full extension of the spring 246 is reached or the downward movement of the plunger housing 245 is arrested (thereby also arresting further extension of the spring 246). In some embodiments, the downward movement of the plunger housing 245 is arrested by the underside surface 302 contacting a top surface of the beam 304.

Release assembly 306 of FIGS. 60A-B includes a body 308, the release tab 249, and a ledge 310. A top end of the body 308 is rotatably coupled to the top end of the shaft 247. The ledge 310 is located proximate to a lower end of the body 308 and is configured to have the underside surface 302 of plunger housing 245 seated on and supported by the ledge 310, thereby holding the plunger housing 245 in an upper position, thereby holding the spring 246 in a compressed position.

The release tab 249 is configured to interact with trigger tab 540 of the release bar trigger 240 (shown on FIGS. 54A-B), whereby the indexing of the ejector assembly 243 causes the release tab 249 of the next ejector 267 to contact the stationary (relative to the plant dispensing unit 237) trigger tab 540. As the indexing of the ejector assembly 243 to the next ejector progresses, the angle of the trigger tab 540 causes the release bar assembly to progressively rotate outward and away from the shaft 247. The outward rotation thereby moves the ledge 310 outward enough so that it removes the ledge 310 from its support of the bracket housing 245, thereby releasing the compressed spring 246. The release of the compressed spring 246 then pushes the bracket housing 245 downward along the shaft 247 with speed, whereby a foot 314 of the plunger housing 245 forcefully and quickly pushes the plant ball 185 off the tines, causing the plant ball 185 to be ejected from the tines 108 with force.

Because the funnel 264 and the release bar trigger 240/trigger tab 540 are fixed to the plant dispensing unit 237 in stationary positions, each The use of the stationary trigger tab 540 to release the spring 246 results in each plant ball 185 being ejected in the same position relative to the funnel 264. This results in greater precision in planting because each plant ball 185 loaded onto the ejector assembly 243 enters the funnel 264 in the substantially same location and with the substantially same trajectory and force.

It will be understood by the skilled artisan that in lieu of the compressible spring 246 shown in FIGS. 60A-B, alternative biasing means may be utilized to provide the ejection force.

FIG. 61A shows a perspective view of one embodiment of a flat feeder 251. FIGS. 61B thru 61E show the flat feeder 251 in various views with other components such as the dispensing unit 237 affixed. The flat feeder 251 is shown with one tray 43 positioned for the ejector assemblies 243 to grab the plant balls 185 from the tray 43 cells. The flat feeder 251 has a cover 255 with view slots 253 in the vertical component. Also shown are brake slots 254 in the vertical component. Brake slots 254 house brake wheels 252 for controlling the downward rate of speed of a newly-loaded tray 43 filled with plant balls 185 (not shown).

FIG. 61D shows the ejector assembly 243 in position to grab plant balls 185 from the tray cells of the tray loaded into the flat feeder 251. The ejector assembly 243 is indexed towards the full plant row of the tray 43 trays in the flat feeder 251 where the tines 108 of the forks 92 grab the plant balls 185 (not shown).

FIG. 61C shows the ejector assembly 243 on the way to eject the plant balls 185 into the funnel 264 of this embodiment.

FIGS. 61A-61E show various views of the combined unit of the dispensing unit 237 and flat feeder 251.

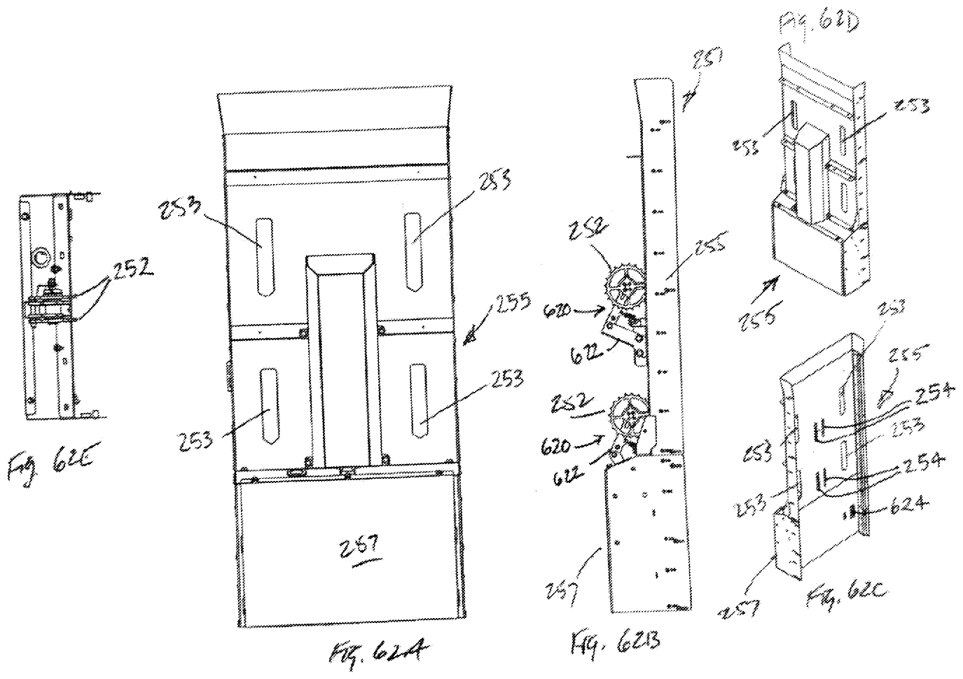

FIGS. 62A-62E shows various elements and views of the flat feeder 251 with tray feeding system 257 and brake system 620 affixed.

The brake system 620 includes brake wheels 252 and passive brake mechanism 622. A portion of the each brake wheel 252 passes through one brake slot 254, whereby the brake wheels 252 engage a new tray as it is dropped in at the top of the cover 255. The engagement of the tray with the brake wheels 252 activates the passive brake mechanism 622, which slows the uncontrolled drop of the new tray 43.

The brake control allows for a plurality of trays 43 to be sequentially loaded into the flat feeder 251 for dispensing without damaging the trays below due to dropping in the new tray from the top of the flat feeder 251 (which must be higher in order to accommodate loading of multiple trays at once). In some embodiments, two, three, four, or five trays 43 may be loaded into the flat feeder 251 such that all trays 43 are in the flat feeder at the same time.

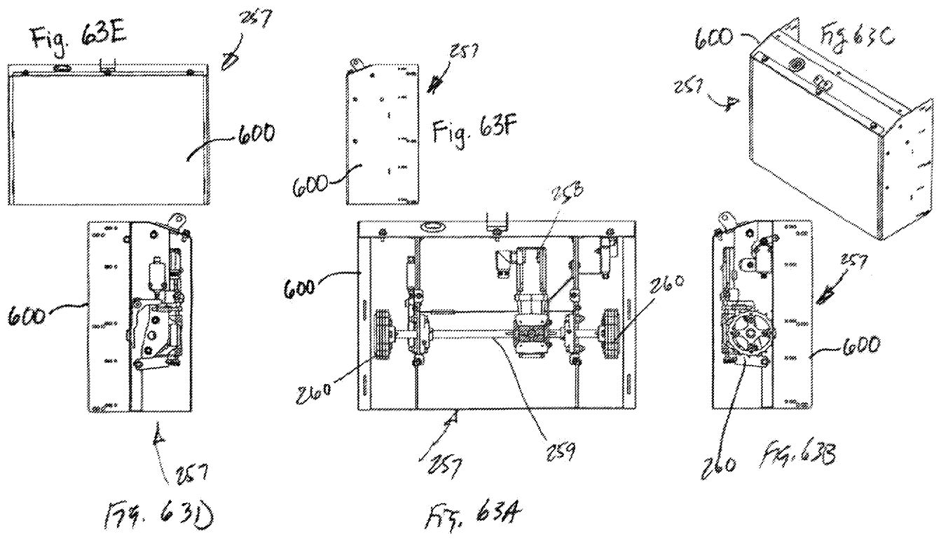

FIGS. 63A-63F show the tray feeding system 257 and various views of some of the components affixed thereto.

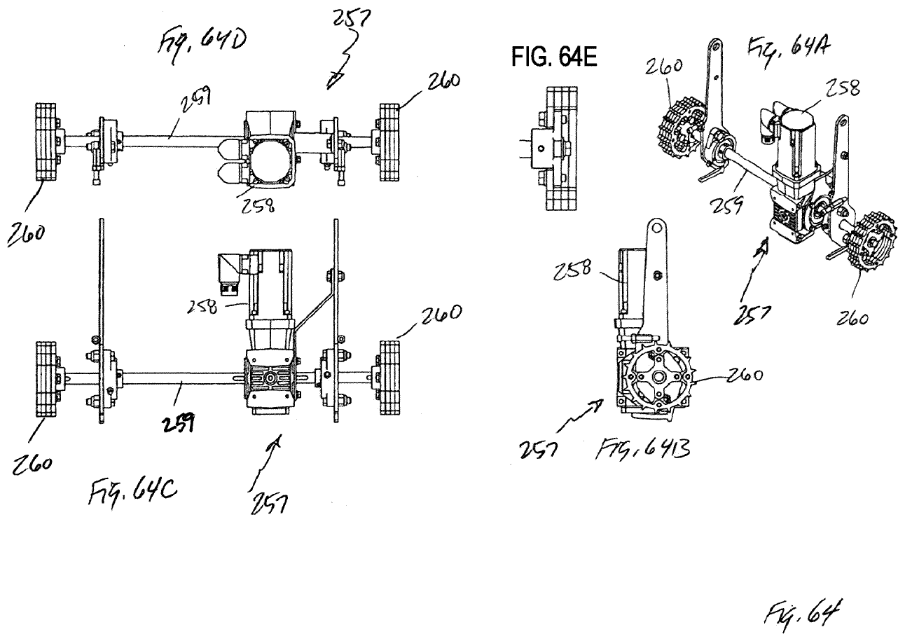

FIGS. 64A-64D shows internal components to the tray feeding system 257 and the interconnection of them.

The tray feeding system 257 includes the feeding system cover 600, which houses the drive components of the tray feeding system 257. The drive components include tray feed drive system 258, drive shaft 259, and index gear/wheel 260. As shown in FIGS. 63A, 63B, and 64D, the tray feed drive system 285 is coupled to and operatively rotates drive shaft 259. Index gears 260 are mounted to the drive shaft 259. The tray feeding system 257 controls the indexing of the tray by components that protrude through corresponding tray feed slots 624 in the flat feeder cover 255 and interact with the rear surface of the tray 43. As the wheels are indexed, the components index the tray downward.

The tray feed drive system 258 in some embodiments includes an electric motor and a drive. In some embodiments the electric motor is a servo motor. In some embodiments the tray feed drive system 258 includes an integrated encoder.

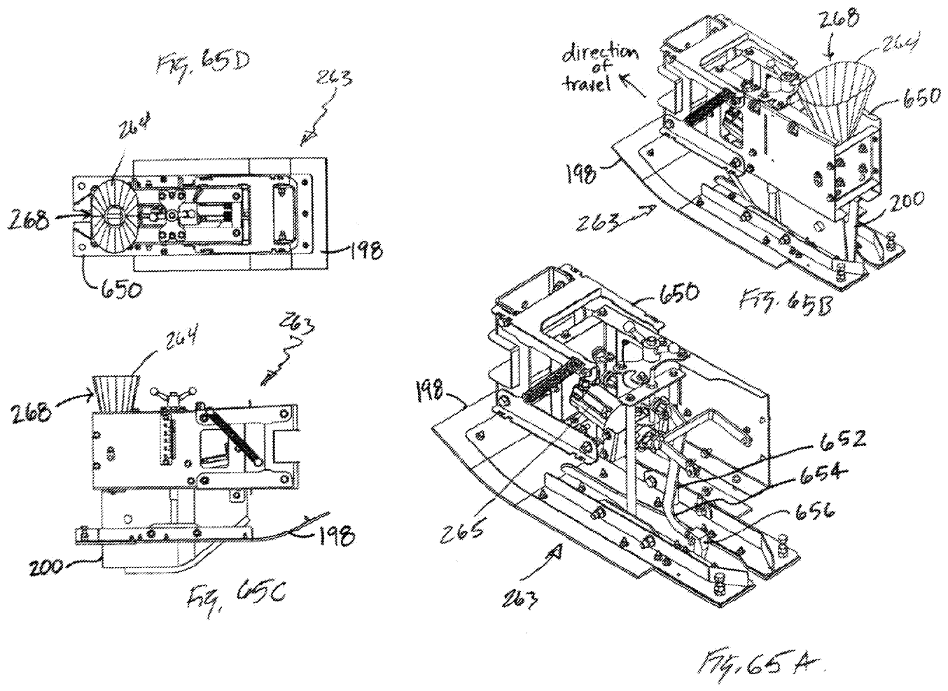

FIG. 65A shows a partial cutaway view of another embodiment of a planting shoe mechanism 263. FIGS. 65B-65D show various views of the shoe mechanism 263 combined with the funnel assembly 268. The shoe mechanism 263 is used for preparing the soil, and for receiving the ejected with force plant and plant ball 185. This embodiment uses a single shoe drive system 265. This single shoe drive system 265 electrically interconnects the various elements of the planting shoe mechanism 263 that prepares the soil for the plant ball 185. Because there is a shoe drive system 265 connected to this shoe mechanism 263 the mechanical components can be controlled more accurately and with more speed. The shoe drive system 265 is interconnected electronically to one or more controllers that interconnects to the other controllers which control the other elements of the dispensing unit 237 to speedily and accurately eject and plant ball 185.

The shoe drive system 265 in some embodiments includes an electric motor and a drive. In some embodiments the electric motor is a servo motor. In some embodiments the shoe drive system 265 includes an integrated encoder.

As previously disclosed above, the shoe mechanism includes the ski 198 and the shoe 200. The ski 198, shoe 200 and funnel 264 are mounted to a shoe frame 650. The shoe frame 650 is located relative to the ejector assemblies 243 such that each ejected plant ball is directly received by the funnel 264. In some embodiments the shoe frame 650 is directly coupled to the dispensing unit frame 542. In other embodiments the shoe frame 650 is coupled to the dispensing unit frame 542 via at least one intermediate frame/element. As previously disclosed herein, the ski 198 rides over the surface of the soil and smooths it in preparation for planting. The shoe 200 includes a front portion which plows a narrow furrow in the soil, and a rear portion that includes two vertically-sloped plates with a gap therebetween The plates travel through the furrow plowed by the front portion of the shoe 200 and also receive the plant ball 185 from the funnel 264.

Shown in FIG. 65A is a kicker assembly 652 comprising an arm 654 and a hammer 656. The kicker assembly 652 is operated by the shoe drive system 265. The kicker assembly 652 is movably coupled to the shoe frame 650 and operationally controlled by the shoe drive system 265 to move forwards and rearwards (relative to the motion of the tractor, i.e. forwards is in the direction of travel of the tractor). In operation, the plant ball 185 is ejected with force from one ejector 267 and travels downwards through the funnel 264 and is guided downwards into the furrow by the rear portion of the shoe 200. The shoe drive system 265 moves the hammer 656 from the forward position to the rearward position, whereby the hammer 656 contacts the plant ball 185 and pushes the plant ball 185 rearward, thus exiting the plant ball 185 through the rear end of the shoe 200 and into the furrow as the dispensing unit travels forward. The shoe drive system 265 then quickly moves the kicker assembly 652 so that the hammer 656 is moved into the forward position to ensure that the hammer 656 is in position to plant the next plant ball 185 before the next plant ball 185 is ejected.

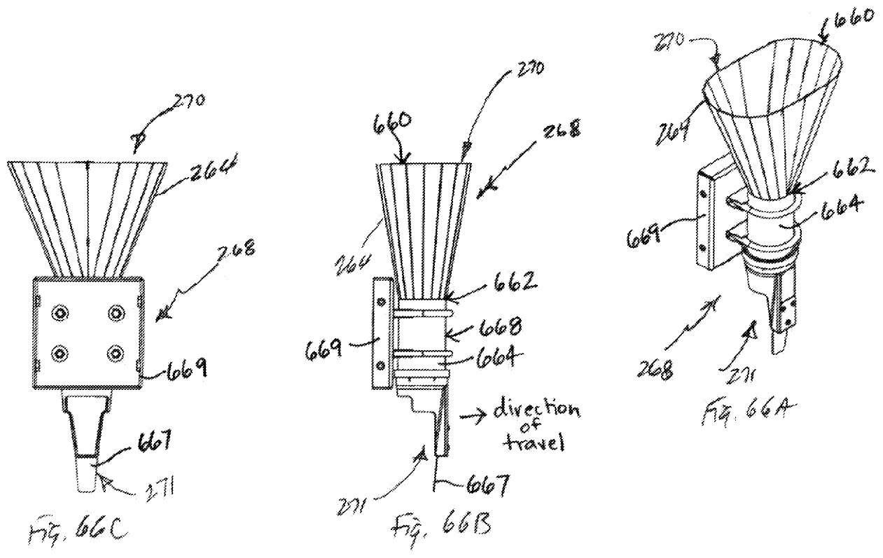

FIG. 66A shows a perspective view of the funnel assembly 268. The funnel assembly 268 has a funnel 264. Also included is structure for assembling to the other components. The funnel 2647 has an input 270 for receiving the ejected plant balls 185 (not shown) and an output 271 for directing the ejected plant balls 185 into the ground. FIGS. 66B and 66C show elevational views of the funnel assembly 268.

The funnel 264 comprises an upper perimeter 660 having an elongated (oval) shape, which transitions to a lower perimeter 662 having a circular shape, as shown in FIG. 66A. The upper perimeter 660 oval shape is oriented such that the long axis of the oval is generally perpendicular to the direction of travel of the plant dispensing unit 237 to allow for plant balls 185 ejected from each side of the plant dispensing unit 237 to enter the input 270. The funnel lower perimeter 662 is coupled to a vertically-oriented tube 664. A guiding tab 667 is coupled to and extends downward from a front side 668 of the tube 664 (where the front side 668 is the side towards the direction of travel). The tube 664 is coupled to a support 669 for mounting to the shoe frame 650, as shown in FIG. 65B. The guiding tab 667 is angled from the vertical towards the support 669, as shown in FIG. 66B.

In operation, the plant ball 185 is ejected with force from the ejector over the top of the funnel, whereby the plant ball enters the funnel and subsequently the tube, and exits through a lower end of the tube. The guiding tab guides the plant ball downwards so that when the plant ball enters the soil below it is located in the proper position relative to the hammer of the shoe mechanism so that the hammer can push the plant ball into the furrow.

Because electronic controls and motors are used and interconnect electronically many of the elements comprising the dispensing unit 237, flat feeder 251, and shoe mechanism 263, these elements can be optimized electronically versus other embodiments of similar mechanical devices for planting balls into the ground. Electronic controls and inter connectivity are used for many of the elements disclosed to thereby enhance function and speed of planting.

Because of the accuracy and speed of these embodiments disclosed, the funnel 264 was optimized in location and design to aid the plant balls 185 to be ejected with force into the ground. The elements disclosed can increase the speed and accuracy of the ejection of plant balls 185 into the ground and the funnel 264 could be thereby decreased in size, shortening the travel time of the plant balls 185 as the accuracy was increased. In other words, because the other elements of this device were optimized with controllers, inter-connectivity and electronics and coordinated in their operation, the funnel 264 could be optimized and this also increases the accuracy and speed in which the plant balls 185 could be planted. Not only is the time to ejection decreased, but the accuracy is increased also.

This increase in speed, accuracy and automation of the improved embodiments enhance the planting efficiency aiding in a more efficient and cost effective mechanical transplanter.

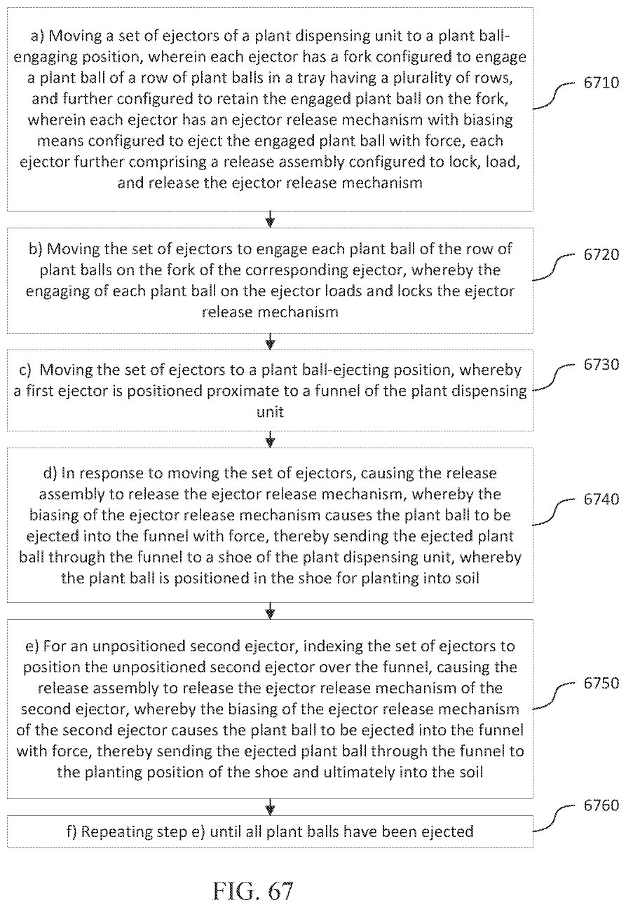

FIG. 67 is a flowchart of an example method for dispensing plants.

At step 6710, a) moving a set of ejectors of a plant dispensing unit to a plant ball-engaging position, wherein each ejector has a fork configured to engage a plant ball of a row of plant balls in a tray having a plurality of rows, and further configured to retain the engaged plant ball on the fork, wherein each ejector has an ejector release mechanism with biasing means configured to eject the engaged plant ball with force, each ejector further comprising a release assembly configured to lock, load, and release the ejector release mechanism,

At step 6720, b) moving the set of ejectors to engage each plant ball of the row of plant balls on the fork of the corresponding ejector, whereby the engaging of each plant ball on the ejector loads and locks the ejector release mechanism,

At step 6730, c) moving the set of ejectors to a plant ball-ejecting position, whereby a first ejector is positioned proximate to a funnel of the plant dispensing unit,

At step 6740, d) in response to moving the set of ejectors, causing the release assembly to release the ejector release mechanism, whereby the biasing of the ejector release mechanism causes the plant ball to be ejected into the funnel with force, thereby sending the ejected plant ball through the funnel to a shoe of the plant dispensing unit, whereby the plant ball is positioned in the shoe for planting into soil,

At step 6750, e) for an unpositioned second ejector, indexing the set of ejectors to position the unpositioned second ejector proximate to the funnel, causing the release assembly to release the ejector release mechanism of the second ejector, whereby the biasing of the ejector release mechanism of the second ejector causes the plant ball to be ejected into the funnel with force, thereby sending the ejected plant ball through the funnel to the planting position of the shoe and ultimately into the soil.

At step 6760, f) repeating step e) until all plant balls have been ejected.

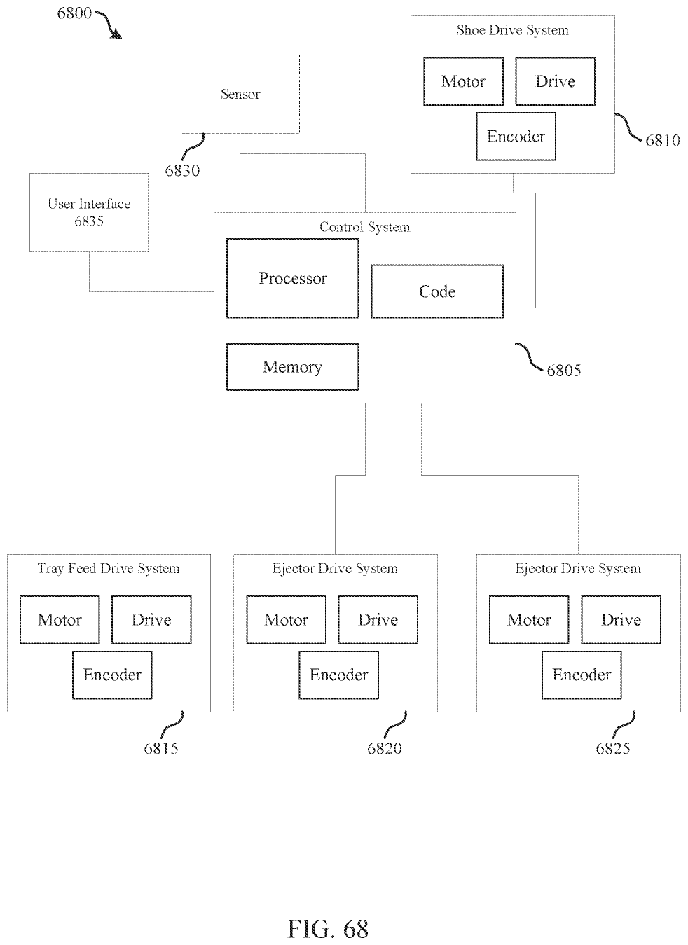

Referring next to FIG. 68, a schematic diagram of the control systems 6800 for the plant dispensing unit is shown.

Control system 6805 includes at least one processor, non-transitory memory, and code. The control system 6805 is connected to a user interface 6835.

Control system 6800 is operatively coupled to shoe drive system 6810, tray feed drive system 6815, first ejector drive system, 6820, and second ejector drive system 6825. The control system 6800 coordinates the timing and other aspects of drive systems 6810, 6815, 6820, and 6825 to synchronize the different planting unit mechanisms to dispense and plant the plant balls 185. The control system 6800 also coordinates the first ejector drive system 6810 with the second ejector drive system 6820 so that they alternate ejecting the plant balls 185 into the funnel 264 and avoid ejecting plant balls 185 into the funnel simultaneously.

Optional sensor 6830 is coupled to the control system for sending information regarding whether a plant ball 185 is engaged on an ejector fork 92, as described above.

Because these electronic controls and motors are used and interconnect electronically many of the elements comprising the dispensing unit 237, flat feeder 251, and shoe mechanism 263, these elements can be optimized electronically versus other embodiments of similar mechanical devices for planting balls into the ground. Electronic controls and inter connectivity are used for many of the elements disclosed to thereby enhance function and speed of planting.

Further aspects of the disclosure are provided by the subject matter of the following clauses:

Clause 1. A plant dispensing unit for planting plants, comprising: a frame including a release bar; an ejector assembly coupled to the frame, the ejector assembly comprising: an ejector assembly housing; a set of ejectors mounted to the ejector assembly housing in a row, wherein each ejector has a fork configured to engage a plant ball of a row of plant balls in a tray having a plurality of rows, and retain the engaged plant ball on the fork, wherein each ejector has an ejector release mechanism with biasing means configured to eject the engaged plant ball with force, and a release assembly configured to load, lock and release the ejector release mechanism; and an ejector drive system configured to translate the set of ejectors horizontally and vertically between a plant ball-engaging position and a plant ball-ejecting position and to index the set of ejectors for ejecting each engaged plant ball into a funnel; a funnel assembly in spaced relation to the frame and including a funnel configured to receive an ejected plant ball and direct it to a shoe; a shoe assembly in spaced relation to the frame, the shoe assembly comprising: the shoe configured to receive the ejected plant ball from the funnel and position the plant ball for planting; a shoe mechanism configured to plant the positioned plant ball into soil; and a shoe drive system configured to operatively control the shoe mechanism to plant the plant ball into the soil; and a control system coupled to the ejector drive system and the shoe drive system, for operatively coordinating actions of the plant dispensing unit, wherein the plant dispensing unit is configured to perform the following actions: a) move the set of ejectors to the plant ball-engaging position, b) move the set of ejectors to engage each plant ball of the row of plant balls on the fork of the corresponding ejector, whereby the engaging of each plant ball on the corresponding ejector loads and locks the ejector release mechanism, c) move the set of ejectors to the plant ball-ejecting position, whereby a first ejector is positioned proximate to the funnel, d) in response to moving the set of ejectors, causing the release assembly to release the ejector release mechanism, whereby the biasing of the ejector release mechanism causes the plant ball to be ejected into the funnel with force, thereby sending the ejected plant ball through the funnel to the planting position of the shoe and ultimately into the soil, e) for an unpositioned second ejector, index the set of ejectors to position the unpositioned second ejector proximate to the funnel, causing the release assembly to release the ejector release mechanism of the second ejector, whereby the biasing of the ejector release mechanism of the second ejector causes the plant ball to be ejected into the funnel with force, thereby sending the ejected plant ball through the funnel to the planting position of the shoe and ultimately into the soil, and f) repeat step e) until all plant balls have been ejected.

Clause 2. The plant dispensing unit of clause 1, the shoe mechanism further comprising: a kicker arm having one end movably coupled to the frame and a free end having a hammer, wherein the hammer is configured to move between forwards and rearwards positions, wherein when the plant ball is positioned in the shoe for planting, the hammer is moved rearwards to contact the plant ball with the hammer, thereby planting the plant ball into the soil.

Clause 3. The plant dispensing unit of clause 2, wherein the shoe drive system is configured to operate the kicker arm so that the hammer moves forwards at a faster rate than the hammer moves rearwards.

Clause 4. The plant dispensing unit of clause 1, further comprising a sensor coupled to the frame and configured to check that the ejector has engaged the plant ball, and wherein the plant dispensing unit is further configured to: for each ejector positioned proximate to the funnel but prior to ejecting, determine using the sensor whether the positioned ejector has engaged the plant ball; and during steps d) and e), releasing the ejector mechanism only upon determining that the positioned ejector has engaged the plant ball.

Clause 5. The plant dispensing unit of clause 4, wherein the sensor is an infrared sensor and the plant dispensing unit further comprises an infrared laser.

Clause 6. The plant dispensing unit of clause 1, the funnel further comprising an upper perimeter having an oval shape and a lower perimeter having a circular shape, and the funnel further comprising a tube coupled to the lower perimeter.

Clause 7. The plant dispensing unit of clause 6, the funnel further comprising a guiding tab extending downwards from a front side of a lower end of the tube.

Clause 8. The plant dispensing unit of clause 1, further comprising a flat feeder coupled to the frame and configured to index the tray of plant balls for engagement of each row of plant balls in the tray.

Clause 9. The plant dispensing unit of clause 8, the flat feeder comprising a tray feeding system comprising: drive components configured to index the tray of plant balls; and a tray feed drive system configured to operate the drive components, wherein the tray feed drive system is coupled to the control system.

Clause 10. The plant dispensing unit of clause 8, the flat feeder further comprising a brake system configured to slow a rate of downward travel of a tray loaded into the flat feeder

Clause 11. The plant dispensing unit of clause 1, wherein the ejector drive system and the shoe drive system each comprise an electric motor and a drive.

Clause 12. The plant dispensing unit of clause 1, wherein the locked release assembly is released by the release bar engaging the release assembly when the ejector is positioned proximate to the funnel, whereby the biasing means of the ejector mechanism is released.

Clause 13. A method for dispensing plants, comprising the steps of: a) moving a set of ejectors of a plant dispensing unit to a plant ball-engaging position, wherein each ejector has a fork configured to engage a plant ball of a row of plant balls in a tray having a plurality of rows, and further configured to retain the engaged plant ball on the fork, wherein each ejector has an ejector release mechanism with biasing means configured to eject the engaged plant ball with force, each ejector further comprising a release assembly configured to lock, load, and release the ejector release mechanism; b) moving the set of ejectors to engage each plant ball of the row of plant balls on the fork of the corresponding ejector, whereby the engaging of each plant ball on the ejector loads and locks the ejector release mechanism, c) moving the set of ejectors to a plant ball-ejecting position, whereby a first ejector is positioned proximate to a funnel of the plant dispensing unit, d) in response to moving the set of ejectors, causing the release assembly to release the ejector release mechanism, whereby the biasing of the ejector release mechanism causes the plant ball to be ejected into the funnel with force, thereby sending the ejected plant ball through the funnel to a shoe of the plant dispensing unit, whereby the plant ball is positioned in the shoe for planting into soil, e) for an unpositioned second ejector, indexing the set of ejectors to position the unpositioned second ejector proximate to the funnel, causing the release assembly to release the ejector release mechanism of the second ejector, whereby the biasing of the ejector release mechanism of the second ejector causes the plant ball to be ejected into the funnel with force, thereby sending the ejected plant ball through the funnel to the planting position of the shoe and ultimately into the soil f) repeating step e) until all plant balls have been ejected.

Clause 14. The method for dispensing plants of clause 13, further comprising the step of: for each plant ball positioned in the shoe, operating a kicker arm of the plant dispensing unit to push the plant ball rearwards, whereby the plant ball is planted into the soil.

Clause 15. The method for dispensing plants of clause 14, further comprising the step of: after operating the kicker arm to push the plant ball rearwards, moving the kicker arm forwards to reset the kicker arm position.

Clause 16. The method for dispensing plants of clause 13, further comprising the steps of: for each ejector positioned proximate to the funnel prior to ejecting, determine using a sensor of the plant dispensing unit whether the positioned ejector has engaged the plant ball; and during steps d) and e), releasing the ejector mechanism only upon determining that the positioned ejector has engaged the plant ball.

Clause 17. The method for dispensing plants of clause 16, wherein the sensor is an infrared sensor and the plant dispensing unit further comprises an infrared laser.

Clause 18. The method for dispensing plants of clause 13, further comprising the step of: when all plant balls in a row have been engaged by ejectors, operating a tray feeding system of the plant dispensing unit to index the next row for engagement.

Clause 19. The plant dispensing unit of clause 1, wherein the causing the release assembly to release the ejector release mechanism further comprises wherein the locked release assembly is released by a release bar engaging the release assembly when the ejector is positioned proximate to the funnel, whereby the biasing means of the ejector mechanism is released.

While the invention herein disclosed has been described by means of specific embodiments, examples and applications thereof, numerous modifications and variations could be made thereto by those skilled in the art without departing from the scope of the invention set forth in the claims.

What is claimed is:

1. A plant dispensing unit for planting plants, comprising:
a frame including a release bar;
an ejector assembly coupled to the frame, the ejector assembly comprising:
an ejector assembly housing;
a set of ejectors mounted to the ejector assembly housing in a row, wherein each ejector has a fork configured to engage a plant ball of a row of plant balls in a tray having a plurality of rows, and retain the engaged plant ball on the fork, wherein each ejector has an ejector release mechanism with biasing means configured to eject the engaged plant ball with force, and a release assembly configured to load, lock and release the ejector release mechanism; and
an ejector drive system configured to translate the set of ejectors horizontally and vertically between a plant ball-engaging position and a plant ball-ejecting position and to index the set of ejectors for ejecting each engaged plant ball into a funnel;
a funnel assembly in spaced relation to the frame and including a funnel configured to receive an ejected plant ball and direct it to a shoe;
a shoe assembly in spaced relation to the frame, the shoe assembly comprising:
the shoe configured to receive the ejected plant ball from the funnel and position the plant ball for planting;
a shoe mechanism configured to plant the positioned plant ball into soil; and
a shoe drive system configured to operatively control the shoe mechanism to plant the plant ball into the soil; and
a control system coupled to the ejector drive system and the shoe drive system, for operatively coordinating actions of the plant dispensing unit, wherein the plant dispensing unit is configured to perform the following actions:
a) move the set of ejectors to the plant ball-engaging position,
b) move the set of ejectors to engage each plant ball of the row of plant balls on the fork of the corresponding ejector, whereby the engaging of each plant ball on the corresponding ejector loads and locks the ejector release mechanism,
c) move the set of ejectors to the plant ball-ejecting position, whereby a first ejector is positioned proximate to the funnel,
d) in response to moving the set of ejectors, causing the release assembly to release the ejector release mechanism, whereby the biasing of the ejector release mechanism causes the plant ball to be ejected into the funnel with force, thereby sending the ejected plant ball through the funnel to the planting position of the shoe and ultimately into the soil,
e) for an unpositioned second ejector, index the set of ejectors to position the unpositioned second ejector proximate to the funnel, causing the release assembly to release the ejector release mechanism of the second ejector, whereby the biasing of the ejector release mechanism of the second ejector causes the plant ball to be ejected into the funnel with force, thereby sending the ejected plant ball through the funnel to the planting position of the shoe and ultimately into the soil, and
f) repeat step e) until all plant balls have been ejected.

2. The plant dispensing unit of claim 1, the shoe mechanism further comprising:
a kicker arm having one end movably coupled to the frame and a free end having a hammer, wherein the hammer is configured to move between forwards and rearwards positions, wherein when the plant ball is positioned in the shoe for planting, the hammer is moved rearwards to contact the plant ball with the hammer, thereby planting the plant ball into the soil.

3. The plant dispensing unit of claim 2, wherein the shoe drive system is configured to operate the kicker arm so that the hammer moves forwards at a faster rate than the hammer moves rearwards.

4. The plant dispensing unit of claim 1, further comprising a sensor coupled to the frame and configured to check that the ejector has engaged the plant ball, and wherein the plant dispensing unit is further configured to:
for each ejector positioned proximate to the funnel but prior to ejecting, determine using the sensor whether the positioned ejector has engaged the plant ball; and
during steps d) and e), releasing the ejector mechanism only upon determining that the positioned ejector has engaged the plant ball.

5. The plant dispensing unit of claim 4, wherein the sensor is an infrared sensor and the plant dispensing unit further comprises an infrared laser.

6. The plant dispensing unit of claim 1, the funnel further comprising an upper perimeter having an oval shape and a lower perimeter having a circular shape, and the funnel further comprising a tube coupled to the lower perimeter.

7. The plant dispensing unit of claim 6, the funnel further comprising a guiding tab extending downwards from a front side of a lower end of the tube.

8. The plant dispensing unit of claim 1, further comprising a flat feeder coupled to the frame and configured to index the tray of plant balls for engagement of each row of plant balls in the tray.

9. The plant dispensing unit of claim 8, the flat feeder comprising a tray feeding system comprising:
drive components configured to index the tray of plant balls; and
a tray feed drive system configured to operate the drive components, wherein the tray feed drive system is coupled to the control system.

10. The plant dispensing unit of claim 8, the flat feeder further comprising a brake system configured to slow a rate of downward travel of a tray loaded into the flat feeder

11. The plant dispensing unit of claim 1, wherein the ejector drive system and the shoe drive system each comprise an electric motor and a drive.

12. The plant dispensing unit of claim 1, wherein the locked release assembly is released by the release bar engaging the release assembly when the ejector is positioned proximate to the funnel, whereby the biasing means of the ejector mechanism is released.

13. A method for dispensing plants, comprising the steps of:
a) moving a set of ejectors of a plant dispensing unit to a plant ball-engaging position, wherein each ejector has a fork configured to engage a plant ball of a row of plant balls in a tray having a plurality of rows, and further configured to retain the engaged plant ball on the fork, wherein each ejector has an ejector release mechanism with biasing means configured to eject the engaged plant ball with force, each ejector further comprising a release assembly configured to lock, load, and release the ejector release mechanism;
b) moving the set of ejectors to engage each plant ball of the row of plant balls on the fork of the corresponding ejector, whereby the engaging of each plant ball on the ejector loads and locks the ejector release mechanism,
c) moving the set of ejectors to a plant ball-ejecting position, whereby a first ejector is positioned proximate to a funnel of the plant dispensing unit,
d) in response to moving the set of ejectors, causing the release assembly to release the ejector release mechanism, whereby the biasing of the ejector release mechanism causes the plant ball to be ejected into the funnel with force, thereby sending the ejected plant ball through the funnel to a shoe of the plant dispensing unit, whereby the plant ball is positioned in the shoe for planting into soil,
e) for an unpositioned second ejector, indexing the set of ejectors to position the unpositioned second ejector proximate to the funnel, causing the release assembly to release the ejector release mechanism of the second ejector, whereby the biasing of the ejector release mechanism of the second ejector causes the plant ball to be ejected into the funnel with force, thereby sending the ejected plant ball through the funnel to the planting position of the shoe and ultimately into the soil
f) repeating step e) until all plant balls have been ejected.

14. The method for dispensing plants of claim 13, further comprising the step of:
for each plant ball positioned in the shoe, operating a kicker arm of the plant dispensing unit to push the plant ball rearwards, whereby the plant ball is planted into the soil.

15. The method for dispensing plants of claim 14, further comprising the step of:
after operating the kicker arm to push the plant ball rearwards, moving the kicker arm forwards to reset the kicker arm position.

16. The method for dispensing plants of claim 13, further comprising the steps of:
for each ejector positioned proximate to the funnel prior to ejecting, determine using a sensor of the plant dispensing unit whether the positioned ejector has engaged the plant ball; and
during steps d) and e), releasing the ejector mechanism only upon determining that the positioned ejector has engaged the plant ball.

17. The method for dispensing plants of claim 16, wherein the sensor is an infrared sensor and the plant dispensing unit further comprises an infrared laser.

18. The method for dispensing plants of claim 13, further comprising the step of:
when all plant balls in a row have been engaged by ejectors, operating a tray feeding system of the plant dispensing unit to index the next row for engagement.

19. The plant dispensing unit of claim 1, wherein the causing the release assembly to release the ejector release mechanism further comprises wherein the locked release assembly is released by a release bar engaging the release assembly when the ejector is positioned proximate to the funnel, whereby the biasing means of the ejector mechanism is released.
